(19) United States
(12) Patent Application Publication
(10) Pub. No.: US 2026/0261103 A1
(43) Pub. Date: Sep. 3, 2026

(54) Wire Strippers

(71) Applicant: Milwaukee Electric Tool Corporation, Brookfield, WI (US)

(72) Inventors: Christian R. Braun, Milwaukee, WI (US); Kyle A. Ritz, Burlington, WI (US); Jedidiah J. Babinec, Milwaukee, WI (US); Richard M. Schieber, Milwaukee, WI (US); Ryan S. Dauss, Milwaukee, WI (US); Claire A. Sigworth, Milwaukee, WI (US); Dalton A. Fitch, Avon, IN (US); Samuel A. Gould, New Berlin, WI (US); Anthony G. Wilcox, Sussex, WI (US)

(21) Appl. No.: 19/451,837

(22) Filed: Jan. 16, 2026

Related U.S. Application Data
(60) Provisional application No. 63/765,210, filed on Feb. 28, 2025.
(60) Provisional application No. 63/787,285, filed on Apr. 11, 2025.
(60) Provisional application No. 63/818,227, filed on Jun. 5, 2025.
(60) Provisional application No. 63/843,420, filed on Jul. 14, 2025.
(60) Provisional application No. 63/908,305, filed on Oct. 30, 2025.

(51) Int. Cl. H02G 1/12; B25B 7/22

(52) U.S. Cl. CPC H02G 1/1251; H02G 1/127; B25B 7/22

(57) ABSTRACT

A powered wire stripping tool including a body, a blade rotatably coupled to the body, and a motor and power source positioned within the body. A channel is formed along the body and defines a recessed surface. The blade has an outer edge that extends into the channel. A first button is coupled to a first side of the body, and a second button is coupled to a second side of the body. When a user presses the first button and the second button, the power source provides power to the motor and the motor rotates the blade such that a workpiece positioned within the channel can be cut by the blade.

### CROSS-REFERENCE TO RELATED PATENT APPLICATIONS

The present application claims the benefit of and priority to U.S. Provisional Application No. 63/908,305 filed on Oct. 30, 2025, U.S. Provisional Application No. 63/843,420 filed on Jul. 14, 2025, U.S. Provisional Application No. 63/818,227 filed Jun. 5, 2025, U.S. Provisional Application No. 63/787,285 filed Apr. 11, 2025, and U.S. Provisional Application No. 63/765,210 filed on Feb. 28, 2025, each of which is incorporated herein by reference in its entirety.

### BACKGROUND OF THE INVENTION

The present invention relates generally to the field of wire stripping tools. The present invention relates specifically wire strippers with features designed to facilitate stripping of a variety of types of wires and cables, such as metallic cables, non-metallic cables, and/or underground feeder cables.

### SUMMARY OF THE INVENTION

One embodiment of the invention relates to a powered wire stripping tool including a body centered on and extending along a longitudinal axis. The body includes a first end, a second end opposite the first end along the longitudinal axis, a first side extending between the first end and the second end, and a second side opposite the first side and extending between the first end and the second end. An internal cavity is defined within the body and enclosed between the first side, the second side, the first end, and the second end. A channel is formed along the body. The channel defines a recessed surface along the body between the first side and the second side. The recessed surface extends along the body from the first end to the second end. A blade is rotatably coupled to the body and has an outer edge that extends into the channel. The wire stripping tool further includes a motor positioned within the internal cavity and configured to rotate the blade and a power source positioned within the internal cavity and configured to provide power to the motor. A first button is coupled to the first side of the body, and a second button is coupled to the second side of the body. When a user presses the first button and the second button, the power source provides power to the motor and the motor rotates the blade such that a workpiece positioned within the channel can be cut by the blade.

Another embodiment of the invention relates to a wire stripper. The wire stripper includes a body with a first end and a second end opposite the first end. The body further includes a first section and a second section. The first section is pivotally coupled to the second section. The first section includes a channel defining a recessed surface along the body between the first end and the second end. The second section extends along a longitudinal axis and defines an internal cavity. A blade is coupled to the second section of the body. The blade is configured to move with respect to the channel. A motor is positioned within the internal cavity and configured to move the blade. A power source is positioned within the internal cavity and configured to provide power to the motor. A lever is pivotally coupled to a first side of the body along the first section of the body. The lever is configured to move the body between an opened position and a closed position. A button is coupled to the second section of the body. When the body is in the closed position, at least a portion of the blade is positioned within the channel. When the body is in the closed position and a user presses the button, the power source provides power to the motor and the motor moves the blade such that a workpiece positioned within the channel can be cut by the blade.

Another embodiment of the invention relates to a wire stripping tool. The wire stripping tool includes a body configure to move between an opened position and a closed position. The body includes a first end and a second end opposite the first end along a longitudinal axis. An internal cavity is defined within the body between the first end and the second end. A channel is formed along the body and extends along a channel axis. The channel defines a recessed surface along the body. The recessed surface extends along the body from the first end to the second end. The wire stripping tool further includes a blade, a motor, and a power source. The blade is rotatably coupled to the body and has an outer edge that extends into the channel when the body is in the closed position. The motor is positioned within the internal cavity and configured to rotate the blade. The power source is positioned within the internal cavity and configured to provide power to the motor. A button is coupled to the body and configured to selectively provide power from the power source to the motor. When a user presses the button, the power source provides power to the motor and the motor rotates the blade. When in the opened position, the channel axis of the channel intersects with the longitudinal axis of the body.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a wire stripping tool, according to an exemplary embodiment;

FIG. 2 is a side view of a first jaw body and a second jaw body of the wire stripping tool of FIG. 1 in an opened position, according to an exemplary embodiment;

FIG. 3 is a side view of the first jaw body and the second jaw body of the wire stripping tool of FIG. 1 in an opened position, according to an exemplary embodiment;

FIG. 4 is a side view of the wire stripping tool of FIG. 1 in use with a non-metallic cable positioned between the first jaw body and the second jaw body, according to an exemplary method of using the wire stripping tool of FIG. 1 to remove a cable jacket;

FIG. 5 is a detailed view of the snipping jaws of the wire stripping tool of FIG. 1, according to an exemplary embodiment;

FIG. 6 is a side view of the wire stripping tool of FIG. 1 in use with a metallic cable positioned within the snipping jaws, according to an exemplary method of using the wire stripping tool of FIG. 1 to remove a cable jacket;

FIG. 7 is a detailed view of the metallic cable positioned within the snipping jaws, according to an exemplary method of using the wire stripping tool of FIG. 1 to remove a cable jacket;

FIG. 8 is a side view of a wire stripping tool, according to an exemplary embodiment;

FIG. 9 is a detailed view of a jacket removal feature of the wire stripping tool of FIG. 8 with an underground feeder cable positioned within the feature, according to an exemplary embodiment;

FIG. 10 is a side view of a first jaw body and a second jaw body of the wire stripping tool of FIG. 8 in use with an underground feeder cable positioned between the self-adjusting stripper mechanisms, according to an exemplary method of using the wire stripping tool of FIG. 8 to remove a cable jacket;

FIG. 11 is a side view of the first jaw body and the second jaw body of the wire stripping tool of FIG. 8 in the closed position with the underground feeder cable positioned between the self-adjusting stripper mechanisms, according to an exemplary method of using the wire stripping tool of FIG. 8 to remove a cable jacket;

FIG. 12 is a side view of the wire stripping tool of FIG. 8 with the underground feeder cable positioned in the slot of the jacket removal feature, according to an exemplary method of using the wire stripping tool of FIG. 8 to remove a cable jacket;

FIG. 13 is a detailed view of a jacket removal feature, according to an exemplary embodiment;

FIG. 14 is a detailed view of the jacket removal feature of FIG. 13, according to an exemplary embodiment;

FIG. 15 is a detailed view of a jacket removal feature, according to an exemplary embodiment;

FIG. 16 is a detailed view of a jacket removal feature, according to an exemplary embodiment;

FIG. 17 is a detailed view of a jacket removal feature, according to an exemplary embodiment;

FIG. 18 is a detailed view of a jacket removal feature, according to an exemplary embodiment;

FIG. 19 is a side view of a wire stripping tool, according to an exemplary embodiment;

FIG. 20 is a side view of the wire stripping tool of FIG. 19 in use with a metallic cable positioned within the channel, according to an exemplary method of using the wire stripping tool of FIG. 19 to remove a cable jacket;

FIG. 21 is a side view of the wire stripping tool of FIG. 19 in use with the metallic cable positioned within the channel and the handle in the locked position, according to an exemplary method of using the wire stripping tool of FIG. 19 to remove a cable jacket;

FIG. 22 is a side view of the wire stripping tool of FIG. 19 with the metallic cable removed from the channel, according to an exemplary method of using the wire stripping tool of FIG. 19 to remove a cable jacket;

FIG. 23 is a side view of a wire stripping tool, according to an exemplary embodiment;

FIG. 24 is a side view of the wire stripping tool of FIG. 23 in an opened position, according to an exemplary embodiment;

FIG. 25 is a detailed view of a front end of the wire stripping tool of FIG. 23, according to an exemplary embodiment;

FIG. 26 is a side view of the wire stripping tool of FIG. 23 in use with a non-metallic cable positioned between the cutting blades, according to an exemplary method of using the wire stripping tool of FIG. 23 to remove a cable jacket;

FIG. 27 is a side view of the wire stripping tool of FIG. 23 used to twist the conductors of the non-metallic cable, according to an exemplary method of using the wire stripping tool of FIG. 23;

FIG. 28 is a side view of the wire stripping tool of FIG. 23 used to twist the conductors of the non-metallic cable, according to an exemplary method of using the wire stripping tool of FIG. 23;

FIG. 29 is a side view of the wire stripping tool of FIG. 23 in use with the non-metallic cable, according to another exemplary method of using the wire stripping tool of FIG. 23 to remove a cable jacket;

FIG. 30 is a side view of the wire stripping tool of FIG. 23 in use with the non-metallic cable positioned between the scoring blades, according to an exemplary method of using the wire stripping tool of FIG. 23 to remove a cable jacket;

FIG. 31 is a detailed view of the front end of the wire stripping tool of FIG. 23 in use with the non-metallic cable positioned between the scoring blades, according to an exemplary method of using the wire stripping tool of FIG. 23 to remove a cable jacket;

FIG. 32 is a detailed view of the front end of the wire stripping tool of FIG. 23 in use with the non-metallic cable positioned between the scoring blades, according to an exemplary method of using the wire stripping tool of FIG. 23 to remove a cable jacket;

FIG. 33 is a top view of the wire stripping tool of FIG. 23 in use with the inner conductors of the non-metallic cable positioned between the U-shaped blades, according to an exemplary method of using the wire stripping tool of FIG. 23;

FIG. 34 is a detailed view of the front end of the handle of the wire stripping tool of FIG. 23 in use with the inner conductor positioned in a hole, according to an exemplary method of using the wire stripping tool of FIG. 23; and

FIG. 35 is a detailed view of the front end of the handle of the wire stripping tool of FIG. 23 in use with the inner conductor positioned in a hole, according to an exemplary method of using the wire stripping tool of FIG. 23;

FIG. 36 is a side view of a wire stripping tool, according to an exemplary embodiment;

FIG. 37 is a perspective view of the wire stripping tool of FIG. 36, according to an exemplary embodiment;

FIG. 38 is a top view of the wire stripping tool of FIG. 36, according to an exemplary embodiment;

FIG. 39 is a side view of the wire stripping tool of FIG. 36 in the opened position, according to an exemplary embodiment;

FIG. 40 is a side view of the wire stripping tool of FIG. 36 in the closed position, according to an exemplary embodiment;

FIG. 41 is a perspective of the wire stripping tool of FIG. 36 with a portion of the body shown in ghost lines, according to an exemplary embodiment;

FIG. 42 is a side view of the wire stripping tool of FIG. 36 in use with metallic cable positioned within the channel, according to an exemplary method of using the wire stripping tool of FIG. 36 to remove a cable jacket;

FIG. 43 is a side view of the wire stripping tool of FIG. 36 in use with metallic cable positioned within the channel, according to an exemplary method of using the wire stripping tool of FIG. 36 to remove a cable jacket;

FIG. 44 is a side view of the wire stripping tool of FIG. 36 in use with metallic cable positioned within the channel, according to an exemplary method of using the wire stripping tool of FIG. 36 to remove a cable jacket;

FIG. 45 is a side view of the wire stripping tool of FIG. 36 in use with metallic cable positioned within the channel, according to an exemplary method of using the wire stripping tool of FIG. 36 to remove a cable jacket;

FIG. 46 is a side view of a wire stripping tool, according to an exemplary embodiment;

FIG. 47 is a perspective view of the wire stripping tool of FIG. 46, according to an exemplary embodiment;

FIG. 48 is a top view of the wire stripping tool of FIG. 46, according to an exemplary embodiment;

FIG. 49 is a side view of the wire stripping tool of FIG. 46 in the opened position, according to an exemplary embodiment;

FIG. 50 is a side view of the wire stripping tool of FIG. 46 in the closed position, according to an exemplary embodiment;

FIG. 51 is a perspective of the wire stripping tool of FIG. 46 with a portion of the body shown in ghost lines, according to an exemplary embodiment;

FIG. 52 is a side view of the wire stripping tool of FIG. 46 in use with metallic cable positioned within the channel, according to an exemplary method of using the wire stripping tool of FIG. 46 to remove a cable jacket;

FIG. 53 is a side view of the wire stripping tool of FIG. 46 in use with metallic cable positioned within the channel, according to an exemplary method of using the wire stripping tool of FIG. 46 to remove a cable jacket;

FIG. 54 is a side view of the wire stripping tool of FIG. 46 in use with metallic cable positioned within the channel, according to an exemplary method of using the wire stripping tool of FIG. 46 to remove a cable jacket;

FIG. 55 is a side view of the wire stripping tool of FIG. 46 in use with metallic cable positioned within the channel, according to an exemplary method of using the wire stripping tool of FIG. 46 to remove a cable jacket;

FIG. 56 is a side view of a wire stripping tool, according to an exemplary embodiment;

FIG. 57 is a perspective view of the wire stripping tool of FIG. 56, according to an exemplary embodiment;

FIG. 58 is a top view of the wire stripping tool of FIG. 56, according to an exemplary embodiment;

FIG. 59 is a side view of the wire stripping tool of FIG. 56 in the opened position, according to an exemplary embodiment;

FIG. 60 is a side view of the wire stripping tool of FIG. 56 in the closed position, according to an exemplary embodiment;

FIG. 61 is a perspective of the wire stripping tool of FIG. 56 with a portion of the body shown in ghost lines, according to an exemplary embodiment;

FIG. 62 is a side view of the wire stripping tool of FIG. 56 in use with metallic cable positioned within the channel, according to an exemplary method of using the wire stripping tool of FIG. 56 to remove a cable jacket;

FIG. 63 is a side view of the wire stripping tool of FIG. 56 in use with metallic cable positioned within the channel, according to an exemplary method of using the wire stripping tool of FIG. 56 to remove a cable jacket;

FIG. 64 is a side view of the wire stripping tool of FIG. 56 in use with metallic cable positioned within the channel, according to an exemplary method of using the wire stripping tool of FIG. 56 to remove a cable jacket;

FIG. 65 is a side view of the wire stripping tool of FIG. 56 in use with metallic cable positioned within the channel, according to an exemplary method of using the wire stripping tool of FIG. 56 to remove a cable jacket;

FIG. 66 is a perspective view of a wire stripping tool, according to an exemplary embodiment;

FIG. 67 is a detailed view of a blade for use with the wire stripping tool of FIG. 66, according to an exemplary embodiment;

FIG. 68 is a perspective view of a wire stripping tool, according to an exemplary embodiment;

FIG. 69 is a side view of a wire stripping tool, according to an exemplary embodiment;

FIG. 70 is a side view of the wire stripping tool of FIG. 69 with a handle in a first position, according to an exemplary embodiment;

FIG. 71 is a side view of the wire stripping tool of FIG. 69 with the handle in a second position, according to an exemplary embodiment;

FIG. 72 is a side view of a wire stripping tool, according to an exemplary embodiment;

FIG. 73 is a top view of the wire stripping tool of FIG. 72, according to an exemplary embodiment;

FIG. 74 is a side view of a wire stripping tool, according to an exemplary embodiment; and

FIG. 75 is a top view of the wire stripping tool of FIG. 74, according to an exemplary embodiment.

### DETAILED DESCRIPTION

Referring generally to the figures, various embodiments of a hand tool, such as a wire stripping tool, are provided. Applicant believes that the wire stripping tools discussed herein provide various advantages over typical tools for wire and cable stripping, including providing greater versatility for stripping different types and sized wires/cables and providing greater ease in jacket removal. In various embodiments, the wire stripping tools discussed herein are configured to strip one or more types of wires and cables (e.g., metallic cables, non-metallic cables, underground feeder cables, etc.). This reduces the number of tools a user needs to accomplish wire and cable stripping tasks. Applicant believes that by reducing the number of tools needed, the hand tools discussed herein also decrease the amount of time it takes to strip wires and cables.

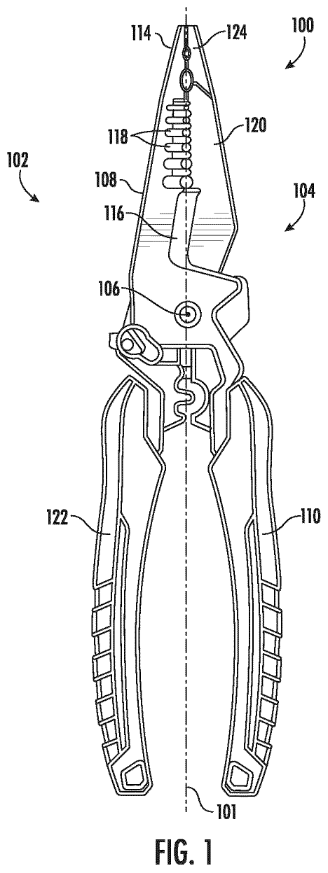

Referring to FIGS. 1-7, a wire stripping tool, such as wire stripper 100, is shown. Wire stripper 100 is configured to receive, cut, and strip the jacket of multiple types/sizes of non-metallic wires and cables (e.g., 14 GA, 12 GA, 10 GA, etc.), non-metallic wires and cables (e.g., 8 AWG wires, 10 AWG wires, 12 AWG wires, 14 AWG wires, 16 AWG wires, and 18 AWG wires), and metallic wires and cables.

Wire stripper 100 is centered on and extends along a longitudinal axis 101. Wire stripper 100 includes a first member 102 and a second member 104. First member 102 includes a first jaw body 108 and a first handle 110 coupled to first jaw body 108. Second member 104 includes a second jaw body 120 coupled to a second handle 122. First jaw body 108, first handle 110, second jaw body 120, and second handle 122 define longitudinal axis 101. Longitudinal axis 101 is centered between first handle 110 and second handle 122.

Second member 104 is pivotably coupled to first member 102. First member 102 and second member 104 are configured to move between an opened position and a closed position with respect to each other around a pivot axis 106. Longitudinal axis 101 intersects with pivot axis 106. As shown, longitudinal axis 101 is perpendicular to pivot axis 106. When moved between the opened position and the closed position, first jaw body 108 and second jaw body 120 pivot with respect to each other towards and away from longitudinal axis 101.

First jaw body 108 includes a first tip 114, a first inner blade 116, and a first plurality of grooves, shown as a first plurality of U-shaped blades 118. In other various embodiments, the first plurality of grooves may be another shaped blade, such as C-shaped blades. First plurality of U-shaped blades 118 are positioned between first inner blade 116 and first tip 114 in a direction along longitudinal axis 101. First plurality of U-shaped blades 118 are defined in first jaw body 108. Each first U-shaped blade 118 is configured (e.g., sized and shaped) to receive a different sized wire for stripping (e.g., 8 AWG-18 AWG). As shown, first jaw body 108 includes six first U-shaped blades 118. First U-shaped blades 118 are positioned in order of size, where the largest U-shaped blade 118 is adjacent to first inner blade 116 (e.g., 8 AWG) and the smallest U-shaped blade 118 is adjacent to first tip 114 (e.g., 18 AWG).

Second jaw body 120 includes a second tip 124, a second inner blade 126, and a second plurality of grooves, shown as a second plurality of U-shaped blades 128. Second plurality of U-shaped blades 128 are positioned between second inner blade 126 and second tip 124. Second plurality of U-shaped blades 128 are defined in second jaw body 120. Each second U-shaped blade 128 is configured (e.g., sized and shaped) to receive a different sized wire for stripping (e.g., 8 AWG-18 AWG). As shown, second jaw body 120 includes six second U-shaped blades 128, which each correspond to a first U-shaped blade 118 formed in first jaw body 108. Together, first U-shaped blades 118 and second U-shaped blades 128 define apertures configured to receive a workpiece.

When a workpiece, such as a wire or cable, is placed within an aperture defined between pairs of first U-shaped blades 118 and second U-shaped blades 128, the U-shaped blades 118, 128 can be used to strip/remove the jacket, or insulation, from the wire/cable. When first member 102 and second member 104 are moved into the closed position, the U-shaped blades 118, 128 make an incision in the jacket. While still in the closed position, a user may strip the jacket from the wire/cable by pulling the U-shaped blades 118, 128 along the length of wire/cable.

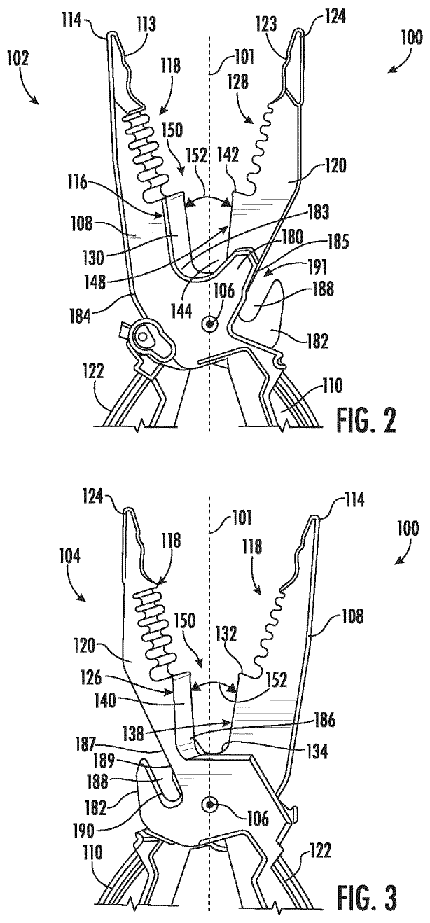

Referring to FIGS. 2-3, first member 102 and second member 104 are in the opened position. When in the opened position, a workpiece may be received between first inner blade 116 of first jaw body 108 and second inner blade 126 of second jaw body 120. Inner blades 116, 126 are configured to cut and/or score a workpiece.

First inner blade 116 of first jaw body 108 has a first linear portion 130, a first lip 132, and a first end 134. First linear portion 130 extends between first lip 132 and first end 134. First linear portion 130 extends away from first jaw body 108 at a first angle 136. First linear portion 130 includes a first cutting edge 138. First lip 132 protrudes from first linear portion 130 and is positioned adjacent to first U-shaped blades 118. First lip 132 has a curved outer surface, which is used to retain a workpiece along first linear portion 130 between first lip 132 and first end 134. First end 134 is positioned opposite first lip 132 along first linear portion 130. First end 134 has a curved outer surface shaped to receive a jacket of a wire/cable.

Second inner blade 126 of second jaw body 120 is substantially the same as first inner blade 116 of first jaw body 108. Second inner blade 126 of second jaw body 120 has a second linear portion 140, a second lip 142, and a second end 144. Second linear portion 140 extends between second lip 142 and second end 144. Second linear portion 140 extends away from second jaw body 120 at a second angle. The second angle is substantially the same as first angle 136. Second linear portion 140 includes a second cutting edge 148. Second lip 142 protrudes from second linear portion 140 and is positioned adjacent to second U-shaped blades 128. Second lip 142 has a curved surface, which is used to retain a workpiece along second linear portion 140 between second lip 142 and second end 144. Second end 144 is positioned opposite second lip 142 along second linear portion 140. Second end 144 has a curved surface shaped to receive a jacket of a wire/cable.

As shown, when in the opened position, first linear portion 130 of first inner blade 116 and second linear portion 140 of second inner blade 126 define a jaw opening 150. In various embodiments, jaw opening 150 is defined by an opening angle 152 between first linear portion 130 and second linear portion 140. More specifically, opening angle 152 is measured between first cutting edge 138 and second cutting edge 148. Opening angle 152 varies as wire stripper 100 is moved between the opened position and the closed position.

Jaw opening 150 is configured to receive a workpiece. In particular, jaw opening 150 is configured to receive different sized wires and cables such that wire stripper 100 may be used to strip a variety of sized wires/cables (e.g., 14 AWG with 2 or 3 conductor wires plus ground in a non-metallic jacket and 10 AWG with 2 or 3 conductor wires plus ground in a non-metallic jacket). When a work piece is positioned between first inner blade 116 and second inner blade 126, the lips 132, 142 assist in retaining the workpiece within jaw opening 150.

In a specific embodiment, when wire stripper 100 is in the opened position, opening angle 152 is at least 15 degrees. In a specific embodiment, when wire stripper 100 is in the opened position, opening angle 152 is no more than 25 degrees. Additionally, the opening angle 152 may vary based on the size of the cable/wire that wire stripper 100 is configured to cut or scored. In a specific embodiment, wire stripper 100 is configured to score different sized wires. In such an embodiment, opening angle 152 is at least 18 degrees. In particular, opening angle 152 is 18.5 degrees when scoring 14 GA non-metallic wires, 20 degrees when scoring 12 GA non-metallic wires, and 21 degrees when scoring 10 GA non-metallic wires.

In a specific embodiment, when a workpiece is received in jaw opening 150 and first inner blade 116 and second inner blade 126 are moved to abut the workpiece, then first linear portion 130 and second linear portion 140 are substantially parallel to each other.

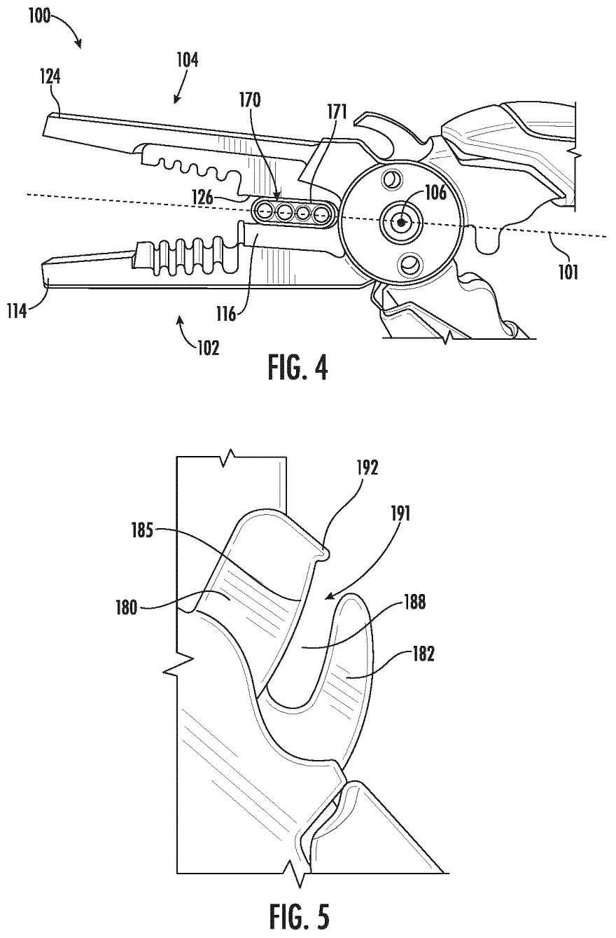

Referring to FIG. 4, a workpiece, shown as cable 170, is received in wire stripper 100 between first member 102 and second member 104. As shown, cable 170 includes a cable jacket 171, and a plurality of wires are positioned within cable jacket 171. In particular, cable 170 is a non-metallic cable with 2 conductor wires and a ground. In order to strip jacket 171 from cable 170, first, cable 170 is positioned within jaw opening 150 between first inner blade 116 and second inner blade 126. Next, wire stripper 100 is moved from the opened position towards the closed position such that jacket 171 is scored by inner blades 116, 126, and opening angle 152 of jaw opening 150 is reduced. Please note that wire stripper 100 does not cut through the wires within cable 170. Finally, the user can use wire stripper 100 or their hands to pull jacket 171 along the length of cable 170, which breaks jacket 171 along the score line and allows a portion of jacket 171 to be removed from cable 170.

Referring to FIGS. 2-3, and 5, wire stripper 100 further includes a snipping jaw for metallic cable jackets. The snipping jaw is defined by a first projection 180 coupled to first jaw body 108 and a second projection 182 coupled to second jaw body 120. First projection 180 extends away from first inner blade 116. Specifically, first jaw body 108 includes a first side 183 and a second side 184 opposite the first side 183. First plurality of U-shaped blades 118 and first inner blade 116 are defined along the first side 183. First projection 180 is coupled to first side 183 and extends away from first side 183 and away from second side 184. First projection 180 has a projection cutting edge 185 defined along an outer wall. Projection cutting edge 185 is located on an outer wall of first projection 180 furthest from first inner blade 116. In a specific embodiment, first projection 180 and first jaw body 108 are formed from a single, unitary, continuous, contiguous piece of material.

Second jaw body 120 includes a third side 186 and a fourth side 187 opposite third side 186. Second plurality of U-shaped blades 128 and second inner blade 126 are defined along the third side 186. Second projection 182 is coupled to fourth side 187 and extends away from fourth side 187, away from third side 186, and away from first jaw body 108. Second projection 182 defines a slot 188. Slot 188 is defined between second projection 182 and fourth side 187. Slot 188 has an inner surface 189. At least a portion of inner surface 189 has a slot cutting edge 190. In a specific embodiment, second projection 182 and second jaw body 120 are formed from a single, unitary, continuous, contiguous piece of material.

When wire stripper 100 is in the opened position, first projection 180 abuts second jaw body 120. First projection 180 is positioned entirely against a rear surface of second jaw body 120 (as shown in FIG. 2). When wire stripper 100 is in the opened position, second projection 182 is spaced a distance away from first projection 180 and away from projection cutting edge 185 of first projection 180. When in the opened position, slot 188 is positioned between first projection 180 and second projection 182. In this way, slot 188 defines a snipping opening 191 configured to receive a workpiece. Snipping opening 191 is defined between projection cutting edge 185 and slot cutting edge 190.

When wire stripper 100 is in the closed position, first projection 180 overlaps with slot 188 and second projection 182 (as shown in FIG. 1). Projection cutting edge 185 is positioned along second projection 182 such that projection cutting edge 185 is located adjacent to slot cutting edge 190. When a workpiece is positioned within slot 188 and wire stripper 100 is moved from the opened position to the closed position, projection cutting edge 185 and slot cutting edge 190 are configured to cut the workpiece.

Referring to FIG. 5, a pincer tip or hook 192 is located at an end of first projection 180. More specifically, hook 192 is coupled to cutting edge 185 and extends away from cutting edge 185, away from first side 183, and away from second side 184. Hook 192 is located adjacent to snipping opening 191 and defines snipping opening 191 with slot cutting edge 190. Hook 192 is configured to retain a workpiece within the snipping jaws when wire stripper 100 is in use. As shown, hook 192 is coupled to first projection 180. In other specific embodiments, hook 192 is coupled to second projection 182.

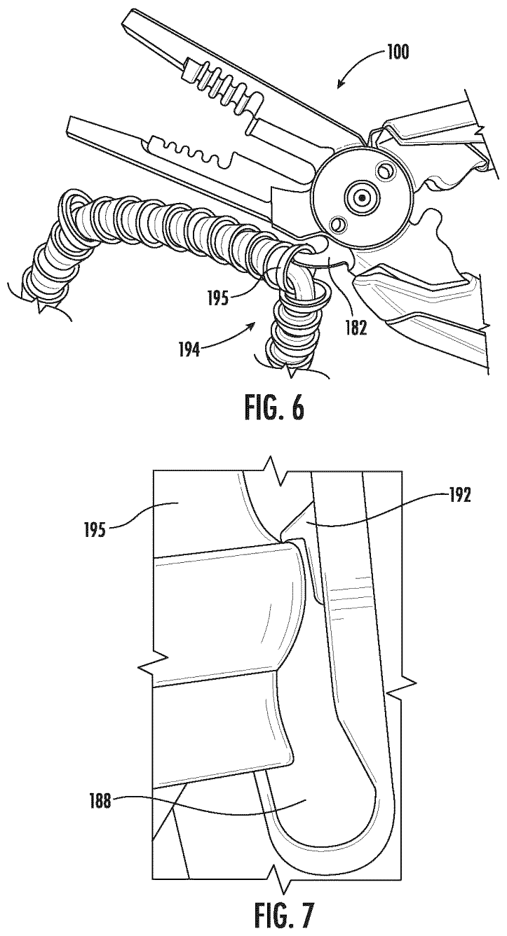

Referring to FIGS. 6-7, a cable 194 is positioned within slot 188. Cable 194 is a metallic cable, or a metal-clad cable, and has a jacket 195 which surrounds a plurality of wires. When wire stripper 100 is moved into the opened position, a user may insert second projection 182 under jacket 195. Hook 192 engages with a portion of jacket 195 to retain cable 194 in slot 188 when wire stripper 100 is moved from the opened position to the closed position. When a user actuates wire stripper 100 into the closed position, first projection 180 and second projection 182 cut through jacket 195. Hook 192 retains jacket 195 in slot 188 when jacket 195 is cut and pushes jacket 195 downwards towards a bottom of slot 188. Specifically, projection cutting edge 185 and slot cutting edge 190 cut jacket 195.

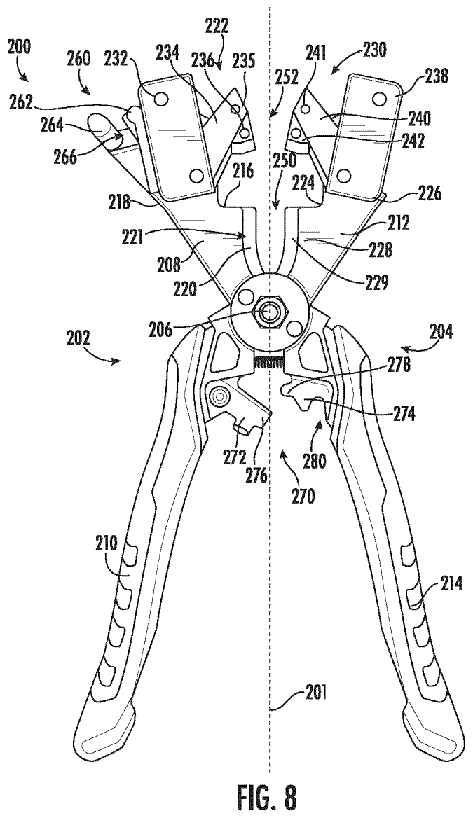

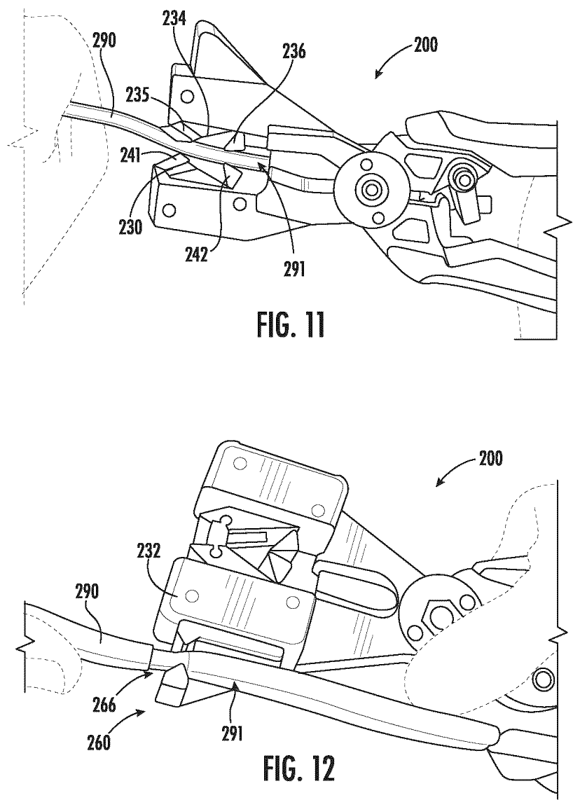

Referring to FIGS. 8-12, a wire stripping tool, such as wire stripper 200, is shown. Wire stripper 200 is configured to receive, cut, and strip the jacket of non-metallic wires and cables and underground feeder wires and cables of various sizes (e.g., 14 AWG, 12 AWG, 10 AWG, etc.). Wire stripper 200 includes a jacket removal feature to assist a user with unsheathing or removing a jacket from a workpiece, such as a wire or cable. Applicant believes that the jacket removal feature provides users with an easier method of removing jackets in comparison to other methods of removal, such as by hand.

Wire stripper 200 is centered on and extends along a longitudinal axis 201. Wire stripper 200 includes a first member 202 and a second member 204. First member 202 includes a first jaw body 208 and a first handle 210 coupled to first jaw body 208. Second member 204 includes a second jaw body 212 coupled to a second handle 214. First jaw body 208, first handle 210, second jaw body 212, and second handle 214 define longitudinal axis 201. Longitudinal axis 201 is centered between first handle 210 and second handle 214.

Second member 204 is pivotably coupled to first member 202. First member 202 and second member 204 are configured to move between an opened position and a closed position with respect to each other around a pivot axis 206. Longitudinal axis 201 intersects with pivot axis 206. As shown, longitudinal axis 201 is perpendicular to pivot axis 206. When moved between the opened position and the closed position, first jaw body 208 and second jaw body 212 pivot with respect to each other towards and away from longitudinal axis 201.

First jaw body 208 includes a first side 216 and a second side 218 opposite first side 216. A first inner blade 220 and a first stripping mechanism 222 are located on first side 216 of first jaw body 208. First inner blade 220 is positioned between stripping mechanism 222 and first handle 210 along longitudinal axis 201. First inner blade 220 includes a cutting edge 221. Cutting edge 221 extends away from first side 216 of jaw body 208 at an angle.

Second jaw body 212 includes a third side 224 and a fourth side 226 opposite third side 224. Third side 224 faces towards first side 216 of first jaw body 208. A second inner blade 228 and a second stripping mechanism 230 are located on third side 224. Second inner blade 228 is positioned between stripping mechanism 230 and second handle 2214 along longitudinal axis 201. Second inner blade 228 includes a cutting edge 229. Cutting edge 229 extends away from third side 224 of jaw body 212 at an angle.

When in the opened position, a workpiece may be received between first inner blade 220 of first jaw body 208 and second inner blade 228 of second jaw body 212. Inner blades 220, 228 are configured to cut and/or score a workpiece. As shown, when in the opened position, first cutting edge 221 and second cutting edge 229 define a jaw opening 250. Jaw opening 250 is configured to receive a workpiece. In particular, jaw opening 250 is configured to receive different sized wires and cables such that wire stripper 200 may be used to strip a variety of sized wires/cables.

First jaw body 208 further includes a protrusion 232 that extends in a direction away from longitudinal axis 201 substantially parallel to pivot axis 206. First stripping mechanism 222 is coupled to first side 216 of jaw body 208 on protrusion 232. In this way, first stripping mechanism 222 is offset from longitudinal axis 201 is a direction perpendicular to longitudinal axis 201. First stripping mechanism 222 is also offset from first inner blade 220 in a direction perpendicular to longitudinal axis 201.

First stripping mechanism 222 is configured to pivot with respect to first member 202. First stripping mechanism 222 includes a first cutting feature with a first pivot arm 234 and a blade 235 and a first gripping feature, or first grip 236. First pivot arm 234 is configured to pivot towards and away from first side 216 when force is applied to pivot arm 234, such as when wire stripper 200 is used on a workpiece. First grip 236 is coupled to first pivot arm 234 and is configured to move with respect to first pivot art 234. Specifically, first grip 236 moves in a direction away from blade 235 and towards first handle 210.

Second jaw body 212 further includes a protrusion 238 that extends in a direction away from longitudinal axis 201 substantially parallel to pivot axis 206. Second stripping mechanism 230 is coupled to third side 224 of jaw body 212 on protrusion 238. In this way, second stripping mechanism 230 is offset from longitudinal axis 201 is a direction perpendicular to longitudinal axis 201. Second stripping mechanism 230 is also offset from second inner blade 228 in a direction perpendicular to longitudinal axis 201.

Second stripping mechanism 230 is substantially the same as first stripping mechanism 222. Second stripping mechanism 230 is configured to pivot with respect to second member 204. Second stripping mechanism 230 includes a second cutting feature with a second pivot arm 240 and a blade 241 and a second gripping feature, or second grip 242. Second pivot arm 240 is configured to pivot towards and away from third side 224 when force is applied to pivot arm 240, such as when wire stripper 200 is used on a workpiece. Second grip 242 is coupled to second pivot arm 240 and is configured to move with respect to second pivot art 240. Specifically, second grip 242 moves in a direction away from blade 241 and towards second handle 214.

Second stripping mechanism 230 is positioned opposite from first stripping mechanism 222. When in the opened position, first stripping mechanism 222 and second stripping mechanism 230 define an opening 252 configured to receive a workpiece. A distance between first stripping mechanism 222 and second stripping mechanism 230 is configured to adjust to the size of a workpiece. Opening 252 is offset from longitudinal axis 201 in a direction perpendicular to longitudinal axis 201. This position allows for a workpiece to not be cut by inner blades 220, 228, when first stripping mechanism 222 and second stripping mechanism 230 are used on the workpiece.

When a workpiece is positioned in opening 252 and wire stripper 200 is moved from the opened position to the closed position, the first stripping mechanism 222 and second stripping mechanism 230 pivot away from each other to adjust the size of opening 252 to the workpiece. Specifically, first grip 236, second grip 242, an outer surface of first pivot arm 234, and an outer surface of second pivot arm 240 each interface with the workpiece. As wire stripper 200 is moved to the closed position, first pivot arm 234 moves towards first side 216 of first jaw body 208 and second pivot arm 240 moves towards third side 224 of second jaw body 212. Blades 235 and 241 then cut into the workpiece, such as a cable jacket. First grip 236 and second grip 242 then move away from blades 235, 241 towards handles 210, 214, which pulls the cable jacket and separates the cable jacket from the rest of the jacket.

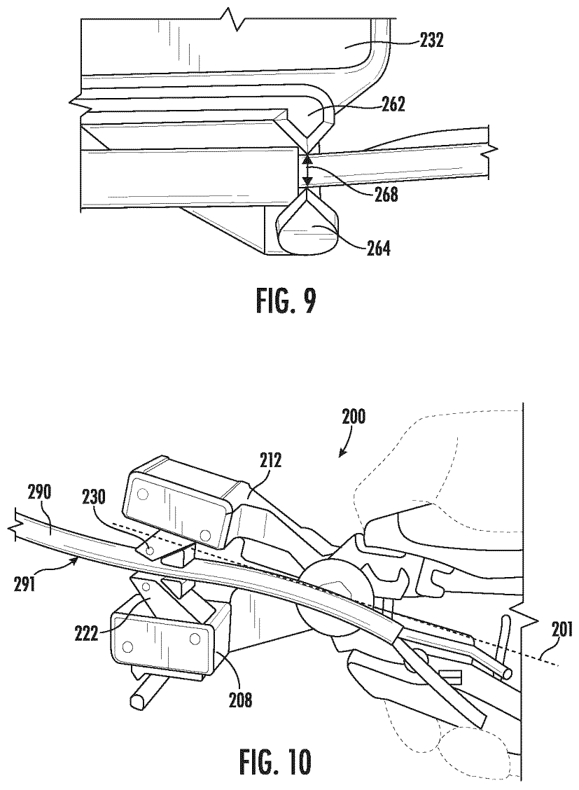

Referring to FIGS. 8 and 9, wire stripper 200 includes a jacket removal feature 260. Jacket removal feature 260 is coupled to second side 218 of first jaw body 208. In particular, jacket removal feature 260 is coupled to protrusion 232 opposite first stripping mechanism 222. As shown, jacket removal feature 260 is coupled to first member 202. In various embodiments, jacket removal feature 260 is coupled to second member 204. In a specific embodiment, jacket removal feature 260 is coupled to fourth side 226 of second jaw body 212 and more specifically to protrusion 238.

Jacket removal feature 260 includes a first projection 262 and a second projection 264. First projection 262 abuts second side 218 of jaw body 208. Second projection 264 is spaced from first projection 262 in a direction substantially perpendicular to longitudinal axis 201. First projection 262 and second projection 264 are spaced from each other and define a channel or slot 266 configured to receive a workpiece. Slot 266 is oriented substantially perpendicular to longitudinal axis 201. In other various embodiments, slot 266 is oriented parallel to longitudinal axis. A first edge of the first projection 262 and a second edge of second projection 264 are configured to wedge behind a cable jacket to assist a user in removing the cable jacket when a user pulls the cable away from the jacket removal feature 260. Slot 266 is sized such that slot 266 may strip a cable jacket but will not interface with inner conductor wires of a cable.

As shown, slot 266 has a single width 268, such that the distance between first projection 262 and second projection 264 is the same along the length of slot 266. In various embodiments, the width of the slot may vary along the length of slot 266 or slot 266 may be adjustable such that slot 266 is configured to receive and strip different sizes of wires/cables. Slot 266 may include a rounded end shaped like a workpiece (e.g., underground feeder cables, non-metallic cables, etc.).

Width 268 of slot 266 is measured between first projection 262 and second projection 264, and more specifically between the first edge of the first projection 262 and the second edge of second projection 264. In a specific embodiment, jacket removal feature 260 is sized to strip 10 AWG underground feeder cables and/or non-metallic cables. In such an embodiment, width 268 is at least 4 mm and at most 4.3 mm. Specifically, width 268 is 4.1 mm to 4.2 mm. In another specific embodiment, jacket removal feature 260 is sized to strip 12 AWG and/or 14 AWG underground feeder cables and/or non-metallic cables. In such an embodiment, width 268 is at least 3 mm and at most 3.3 mm. Specifically, width 268 is 3.1 mm to 3.2 mm.

Wire stripper 200 further includes a locking mechanism 270 configured to limit the movement of first member 202 and second member 204 with respect to each other. Locking mechanism includes a lever 272 and a lock 274. Lever 272 is coupled to first handle 210 and is configured to pivot with respect to first handle 210. Lever 272 includes a step 276. Lock 274 is coupled to second handle 214 and includes a projection 278 and a recess 280.

Lever 272 is configured to actuate between a locked position and an unlocked position. When lever 272 is moved into the locked position and step 276 engages with projection 278, wire stripper 200 is retained in the opened position such that first member 202 and second member 204 are unable to change the angle of opening 250. When lever 272 is moved into the locked position and step 276 engages with recess 280, wire stripper 200 is retained in the closed position.

Referring to FIGS. 10-12, a method of using wire stripper 200 to cut and/or strip a workpiece, such as cable 290, is shown. As shown, cable 290 is an underground feeder cable. Cable 290 has a jacket 291. A user inserts cable 290 between first stripping mechanism 222 and second stripping mechanism 230. As shown, the user can side-load cable (i.e., insert cable in a direction perpendicular to longitudinal axis 201) at the desired position for cutting/stripping, or the user can load cable from the front (i.e., insert cable in a direction parallel to longitudinal axis). A user then moves wire stripper 200 into the closed position and squeezes wire stripper 200. This movement scores cable jacket 291 of cable 290 and cuts cable jacket 291. Specifically, first pivot arm 234 moves towards first jaw body 208 and second pivot arm 240 moves towards second jaw body 212. Blades 235 and 241 then cut cable jacket 291. First grip 236 and second grip 242 then move away from blades 235, 241 towards handles 210, 214, which pulls cable jacket 291 and separates cable jacket 291 from the rest of cable 290. A user may then pull cable 290 while still holding wire stripper 200 in the closed position to further separate cable jacket 291 from cable 290. Then, the user moves cable 290 from stripping mechanisms 222, 230 and positions cable 290 in slot 266 of jacket removal feature 260. Cable 290 is positioned such that the cut portion of cable jacket 291 interfaces with edges of slot 266. A user then pulls on cable 290 in a direction away from jacket removal feature 260 which removes cable jacket 291 from cable 290.

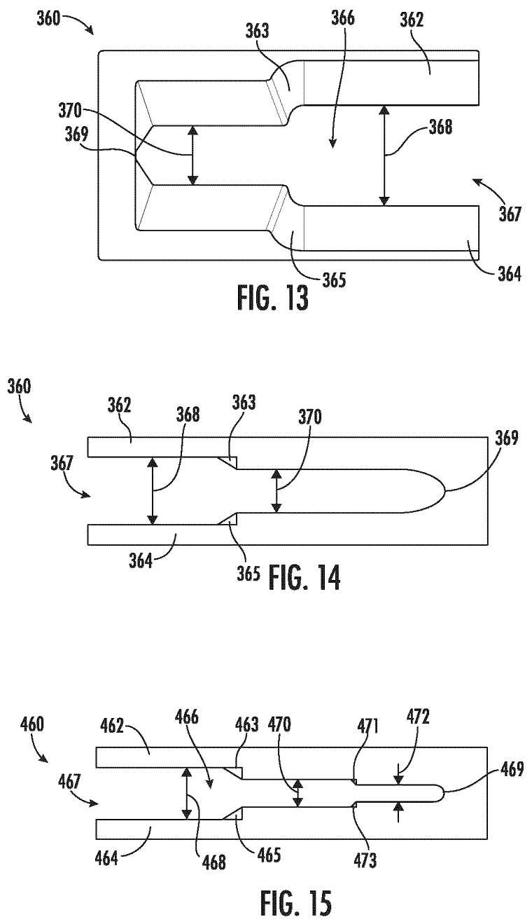

Referring to FIGS. 13-18, various embodiments of jacket removal features that may be utilized with a wire stripping tool, such as wire stripper 200, are shown and described. Specifically, referring to FIGS. 13-14, jacket removal feature 360 is shown and described. Jacket removal feature 360 is substantially the same as jacket removal feature 260 except for the differences discussed herein. Specifically, jacket removal feature 360 is configured to receive different sizes of cables (e.g., 10 AWG, 12 AWG, 14 AWG, etc.) and is configured to receive inner conductor wires. Jacket removal feature 360 includes a first projection 362, a second projection 364, and a slot 366 defined by first projection 362 and second projection 364. First projection 362 includes a first step 363 and second projection 364 includes a second step 365 positioned opposite first step 363. As shown, steps 363, 365 are rounded to define a lip along the length of jacket removal feature 360. A first width 368 is defined along slot 366 between an opening 367 of slot 366 and steps 363, 365. A second width 370 is defined along slot 366 between steps 363, 365, and an end 369 of slot 366. In a specific embodiment, first width 368 is sized to receive 10 AWG cables and second width is configured to receive 12 AWG and/or 14 AWG cables. In such an embodiment, first width 368 is greater than second width 370.

A first length of slot 366 measured between opening 367 and steps 363, 365 is at least 50% the width of a workpiece. Similarly, a second length of slot 366 measured between steps 363, 365 and end 369 is at least 50% the width of a workpiece. These lengths allow for greater contact between the cable jacket of a workpiece and the edges of projections 362, 364 in order to remove a jacket from a workpiece.

End 369 of slot 366 is configured to interface with an inner conductor of a cable to remove a jacket or outer coating of an inner conductor. As shown, end 369 may be tapered or rounded in order to receive an inner conductor.

Referring to FIG. 15, a jacket removal feature 460 is shown. Jacket removal feature 460 is substantially the same as jacket removal features 260 and 360, except for the differences discussed herein. Specifically, jacket removal feature 460 includes two steps such that slot 466 is configured to receive three different sized workpieces (e.g., 10 AWG, 12 AWG, and 14 AWG cables).

Jacket removal feature 460 includes a first projection 462, a second projection 464, and a slot 466 defined by first projection 462 and second projection 464. First projection 462 includes a first step 463 and a second step 471. Second projection includes a third step 465 and a fourth step 473. First step 463 and third step 465 are positioned opposite each other along slot 466. Second step 471 and fourth step 473 are positioned opposite each other along slot 466. First step 463 and third step 465 are located closer to an opening 467 of slot 466 along the length of slot 466, while second step 471 and fourth step 473 are located closer to an end 469 of slot 466. A first width 468 is defined along slot 466 between opening 467 and steps 463, 465. A second width 470 is defined along slot 466 between steps 463, 465 and steps 471, 473. A third width 472 is defined along slot 466 between steps 471, 473 and end 469 of slot 466. In a specific embodiment, first width 468 is sized to receive 10 AWG cables, second width 470 is configured to receive 12 AWG and third width 472 is sized to receive 14 AWG cables. In such an embodiment, first width 468 is greater than second width 470, and second width 470 is greater than third width 472. End 469 of slot 466 is configured to interface with an inner conductor of a cable to remove a jacket or outer coating of the inner conductor.

Referring to FIG. 16, a jacket removal feature 560 is shown. Jacket removal feature 560 is substantially the same as jacket removal features 260, 360, and 460, except for the differences discussed herein. Specifically, jacket removal feature 560 is tapered along the length of slot 566 to accommodate different sizes of cables (e.g., 10 AWG, 12 AWG, and 14 AWG cables). Jacket removal feature 560 includes a first projection 562, a second projection 564, and slot 566 defined by first projection 562 and second projection 564. First projection 562 and second projection 564 are angled towards each other such that a width measured at an opening 567 of slot 566 is greater than any width along the length of slot between opening 567 and an end 569 of slot 566. End 569 of slot 566 is configured to interface with an inner conductor of a cable to remove a jacket or outer coating of the inner conductor. In a specific embodiment, jacket removal feature is configured to receive 10 AWG cables, 12 AWG cables, and 14 AWG cables such that opening 567 has a first width greater than a second width defined at end 569 of slot 566.

Referring to FIG. 17, a jacket removal feature 660 is shown. Jacket removal feature 660 is substantially the same as jacket removal feature 260, except for the differences discussed herein. In particular, second projection 664 is movable with respect to first projection 662 to adjust the width of slot 666.

Jacket removal feature 660 includes first projection 662, second projection 664, and slot 666 defined by first projection 662 and second projection 664. Second projection 664 is movably coupled to first projection 662 via a screw, such as worm screw 663. A user may manually adjust the width of slot 666 by moving second projection 664 along screw 663 towards and away from first projection 662. In a specific embodiment, a maximum width of slot 666 is configured for 10 AWG cables and a minimum width of slot 666 is configured for 14 AWG cables.

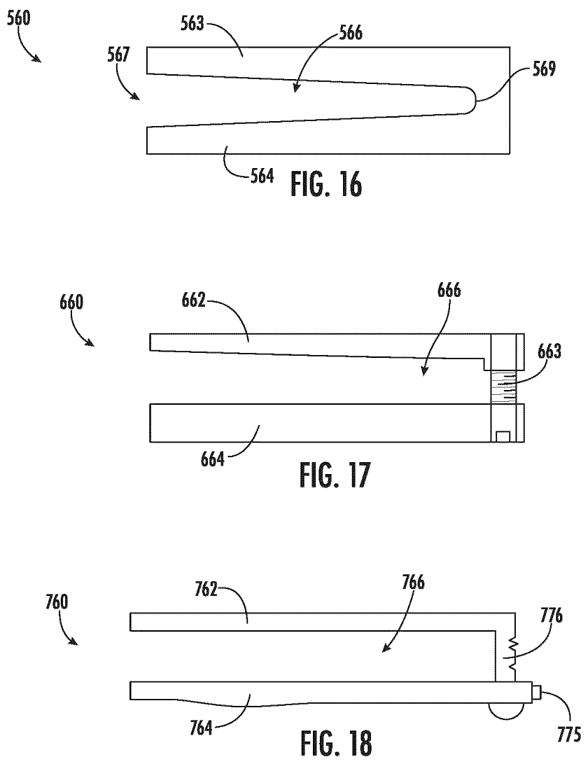

Referring to FIG. 18, a jacket removal feature 760 is shown. Jacket removal feature 760 is substantially the same as jacket removal feature 660, except for the differences discussed herein. Specifically, jacket removal feature 760 includes a button 775 and a plurality of grooves 776. When button 775 is pressed, a user can move second projection 764 towards and away from first projection 762 to adjust the width of slot 766. Second projection 764 will lock in place when engaged with one of the plurality of grooves 776. In a specific embodiment, jacket removal feature 760 includes three grooves sized for three different sized cables (e.g., 10 AWG, 12 AWG, and 14 AWG).

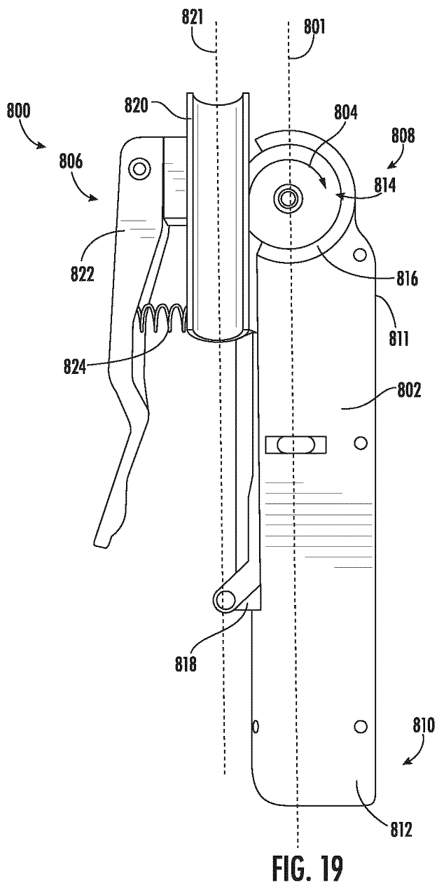

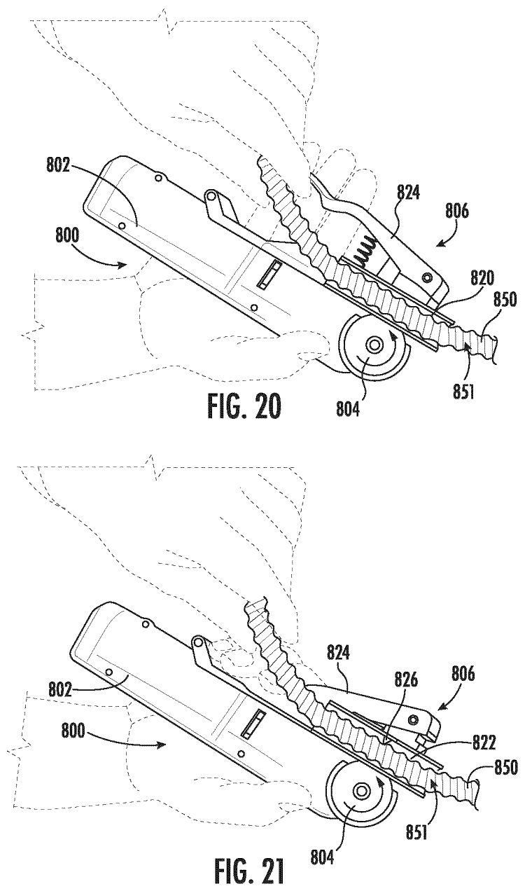

Referring to FIGS. 19-22, a wire stripping tool, such as wire stripper 800, is shown. Wire stripper 800 is configured to receive, strip, and cut various sizes of metallic cables (e.g., 14 AWG with 1, 2, or 3 conductor wires plus ground in a metal clad jacket, and 12 AWG with 1, 2, or 3 conductor wires plus ground in a metal clad jacket, or 10 AWG with 1 or 2 conductor wires plus ground in a metal clad jacket). Wire stripper 800 includes an electrically powered blade that rotates to strip and/or cut metallic cable jackets. Applicant believes that by being electrically powered wire stripper 800 provides benefits over hand-powered wire strippers, which include a crank or lever that a user must rotate, such as being easier to use due to the blade being electrically (rather than manually) rotated and being easier to store due to the wire stripper being more compact.

Referring to FIG. 19, wire stripper 800 includes a body 802, a blade 804, and a lever 806. Body 802 includes a first end 808 and a second end 810 opposite first end 808 along a longitudinal axis 801. Body 802 defines an internal cavity between first end 808 and second end 810. The internal cavity is configured to house a power source, such as a battery, and a motor. The motor is configured to rotate blade 804. The power source is configured to provide power to the motor. Body 802 includes an actuator, shown as button 811, configured to selectively provide power to the motor. When a user presses button 811, power is provided from the power source to the motor, and the motor rotates blade 804.

Body 802 includes an end cap 812 coupled to second end 810. When end cap 812 is removed from body 802, internal cavity can be accessed by a user. In particular, the power source, such as a battery, can be installed or replaced when user removes end cap 812. In a specific embodiment, additional blades can be stored in the internal cavity and can be accessed by a user when end cap 812 is removed.

Blade 804 is rotatably coupled to body 802 at first end 808. Blade 804 is coupled to the motor and will rotate when motor receives power from the power source. As shown, blade 804 is a circular shape. Blade 804 includes a cutting edge or outer edge 814 configured to cut a workpiece. As shown, body 802 includes a ridge 816 that surrounds a portion of outer edge 814 along body 802.

Lever 806 is pivotally coupled to body 802 between first end 808 and second end 810. As shown, body 802 includes a projection 818 and an end of lever 806 is coupled to projection 818. Lever 806 defines a channel 820 that extends along a channel axis 821. Channel 820 is configured to receive a workpiece, such as a metallic cable.

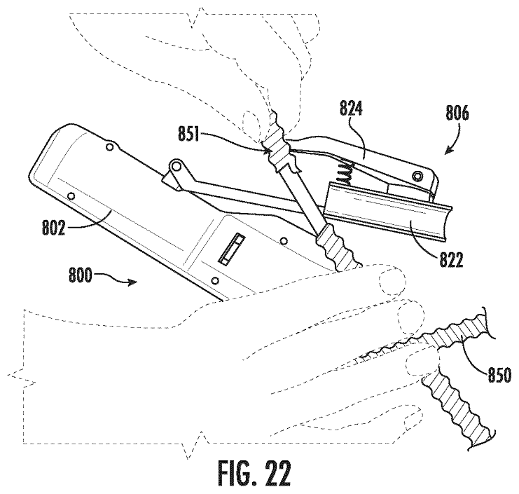

Lever 806 is configured to pivot between a first position and a second position with respect to body 802. When lever 806 is in the first position, lever 806 abuts an outer surface of body 802 and channel axis 821 is substantially parallel to longitudinal axis 801. When lever 806 is moved from the first position to the second position (as shown in FIG. 22), channel 820 is moved away from body 802. When in the first position, blade 804 extends into channel 820. Specifically, outer edge 814 extends into channel 820 and is configured to engage with a workpiece positioned within channel 820.

Lever 806 includes a handle 822. Handle 822 is configured to move between a locked position and an unlocked position. Lever 806 includes a biasing mechanism, shown as spring 824 configured to bias handle 822 towards the unlocked position. When in the unlocked position, lever 806 can pivot between the first position and the second position. When in the locked position, handle 822 actuates a pin 826 (shown in FIG. 21) that is configured to engage with a workpiece to retain the workpiece in channel 820.

Referring to FIGS. 20-22, a method of using wire stripper 800 to cut a workpiece, such as cable 850, is shown. As shown, cable 850 is a metallic cable, or a metal clad cable. Cable 850 has a jacket 851. First, cable 850 is placed within channel 820 and lever 806 is moved into the first position. Second, a user squeezes handle 822 to move lever 806 into the locked position and to have pin 826 engage cable jacket 851 to retain cable 850 in channel 820. Then, a user presses button 811 and continues to squeeze handle 822. When button 811 is pressed, blade 804 rotates and cuts cable jacket 851. After cable jacket 851 is cut, a user can remove cable 850 from channel 820. Lever 806 can be moved from the first position to the second position. A user may then remove cable jacket 851 by twisting jacket 851 along the cut and pulling the cable jacket 851 from cable 850.

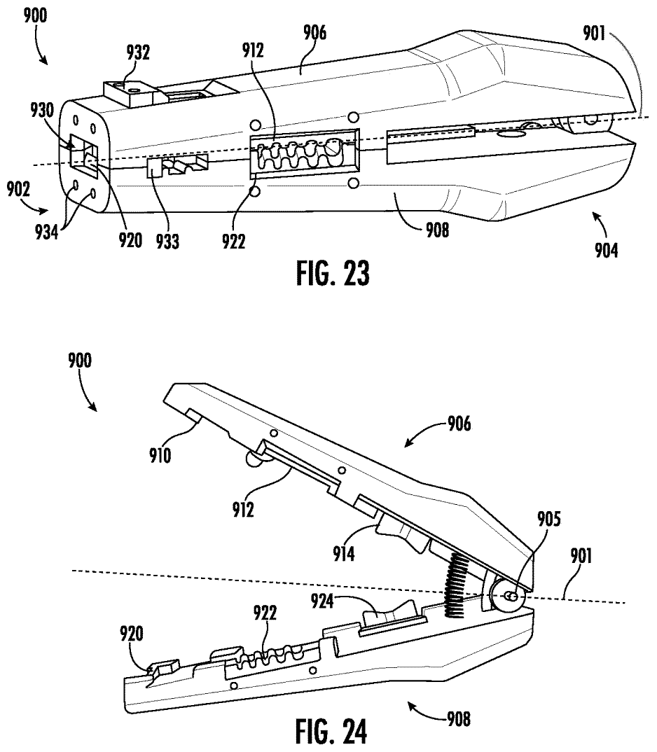

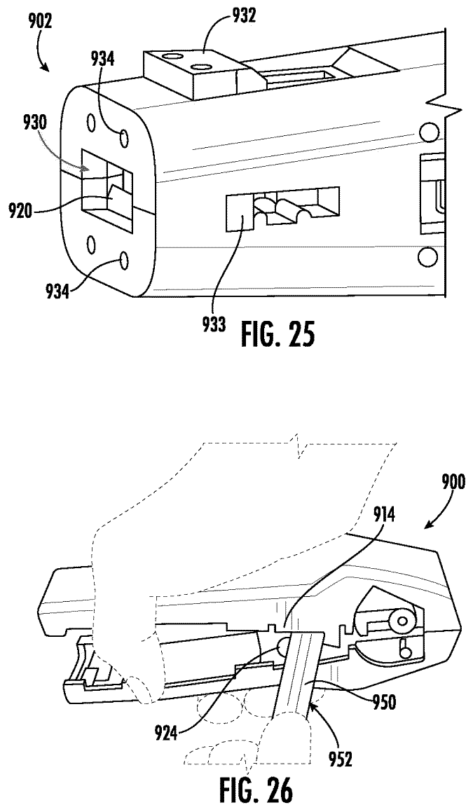

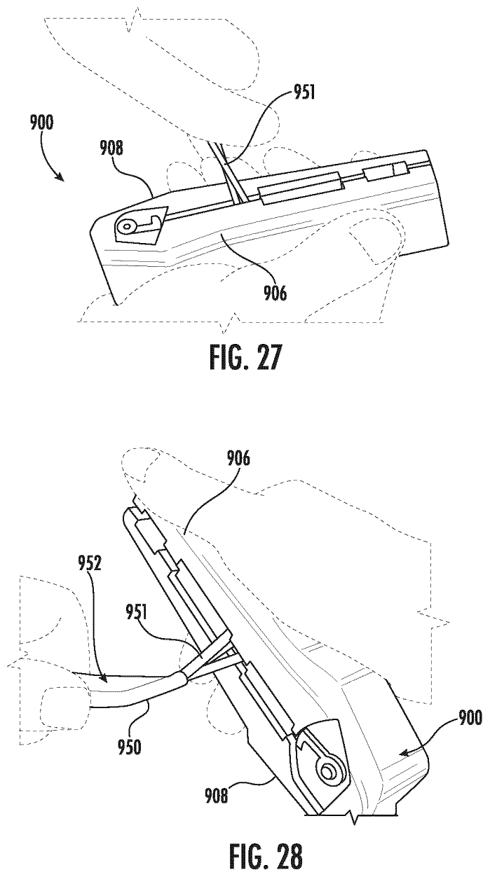

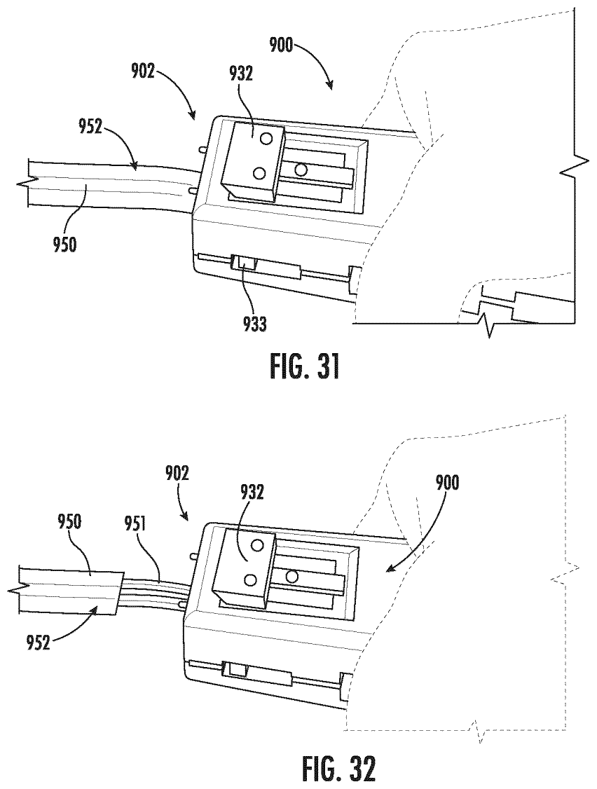

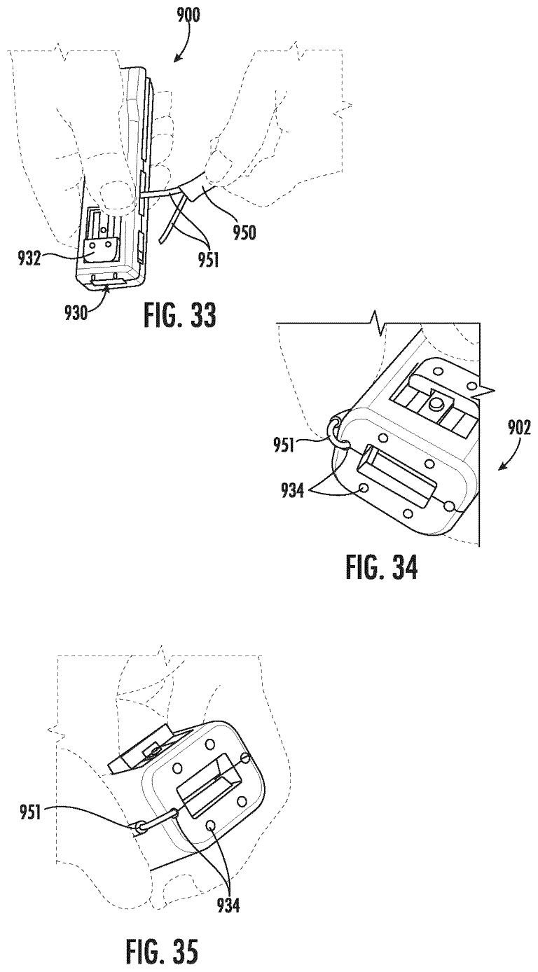

Referring to FIGS. 23-35, a wire stripping tool, such as wire stripper 900 is shown. Wire stripper 900 is configured to strip and/or cut the jackets of non-metallic cables, such as 10 AWG, 12 AWG, and 14 AWG cables. Additionally, wire stripper 900 is configured to strip and/or cut the jackets of inner conductors of a non-metallic cable. Applicant believes that wire stripper 900 provides various benefits over other non-metallic wire strippers by providing a wire stripper with multiple types of blades needed for various stripping tasks which reduces the number of tools needed to accomplish these tasks. Applicant also believes that the shape and size of wire stripper 900 provides the benefit of a more compact tool that is easier to use in tighter spaces, such as inside of an electrical box.

Referring to FIGS. 23-25, wire stripper 900 extends along a longitudinal axis 901 between a first end 902 and a second end 904. Wire stripper 900 includes a first member 906 and a second member 908. Second member 908 is pivotally coupled to first member 906. First member 906 and second member 908 are configured to rotate between an opened position (shown in FIG. 24) and a closed position (shown in FIG. 23) with respect to each other about a pivot axis 905. Pivot axis 905 intersects longitudinal axis 901. As shown, pivot axis 905 is perpendicular to longitudinal axis 901.

First member 906 includes a first scoring blade 910, a first plurality of grooves shown as first U-shaped blades 912, and a first cutting blade 914. First scoring blade 910 is located at first end 902 of wire stripper 900. First cutting blade 914 is spaced away from first end 902 towards second end 904. First U-shaped blades 912 are positioned between first scoring blade 910 and first cutting blade 914 in a direction along longitudinal axis 901. Each first U-shaped blade 912 is configured (e.g., sized and shaped) to receive a different sized wire for stripping (e.g., 8 AWG-18 AWG). In other various embodiments, the first plurality of grooves may be another shaped blade, such as C-shaped blades.

Second member 908 is substantially the same as first member 906. Second member 908 includes a second scoring blade 920, a second plurality of grooves shown as second U-shaped blades 922, and a second cutting blade 924. Second scoring blade 920 is located at first end 902 of wire stripper 900 and positioned opposite a first scoring blade 910 when wire stripper 900 is in the closed position. Second cutting blade 924 is spaced away from first end 902 towards second end 904 and is positioned opposite first cutting blade 914 when wire stripper 900 is in the closed position. Second U-shaped blades 922 are positioned between second scoring blades 920 and second cutting blades 924 in a direction along longitudinal axis 901. Each first U-shaped blades 912 are configured (e.g., sized and shaped) to receive a different sized wire for stripping (e.g., 8 AWG-18 AWG). In other various embodiments, the first plurality of grooves may be another shaped blade, such as C-shaped blades. Together, first U-shaped blades 912 and second U-shaped blades 922 define apertures configured to receive a workpiece.

When a workpiece, such as a wire or cable, is placed within an aperture defined between pairs of first U-shaped blades 912 and second U-shaped blades 922, the U-shaped blades 912, 922 can be used to strip/remove the jacket, or insulation, from the wire/cable. When first member 906 and second member 908 are moved into the closed position, the U-shaped blades 912, 922 make an incision in the jacket. While still in the closed position, a user may strip the jacket from the wire/cable by pulling the U-shaped blades 912, 922 along the length of wire/cable.

An opening 930 is defined between first scoring blade 910 and second scoring blade 920 when in the closed position. Wire stripper 900 includes a slider 932 coupled to first member 906. Slider 932 is configured to adjust the size of opening 930 to allow for scoring of different sized wire/cable jackets. As shown, slider 932 can adjust the size of opening 930 to allow for scoring of three different sized non-metallic jackets (e.g., 10 AWG, 12 AWG, and 14 AWG). Slider 932 includes a projection 933 that extends between first member 906 and second member 908 to adjust the size of opening 930. Specifically, projection 933 prevents first member 906 and second member 908 from closing more than a specific distance between each other.

In various embodiments, wire stripper 900 includes features for twisting and/or clamping a workpiece, such as inner conductors of a non-metallic cable. In other various embodiments, wire stripper 900 includes features for creating J-hooks and/or terminating the ends of a workpiece, such as an end of an inner conductor of a non-metallic cable. As shown, wire stripper 900 includes holes 934 configured to receive a workpiece to create a J-hook or terminate the end of a wire.

Referring to FIGS. 26-28, a method of using wire stripper 900 to cut a workpiece, such as cable 950 is shown. As shown, cable 950 is a non-metallic cable with conductor wires 951 located within a cable jacket 952. A user may cut or score cable 950 by placing cable 950 between first cutting blade 914 and second cutting blade 924 and then squeezing wire stripper 900 into the closed position. A user may then remove a portion of cable jacket 952 from cable 950 and reveal conductors 951. Conductors 951 may be twisted or bent by placing the conductors 951 between first member 906 and second member 908 and holding wire stripper 900 in the closed position. Specifically, conductors 951 are held between an edge of first member 906 and a corresponding edge of second member 908. In this way, conductors 951 are clamped between first member 906 and second member 908 and will resist sliding as a user twists and bends conductors 951.

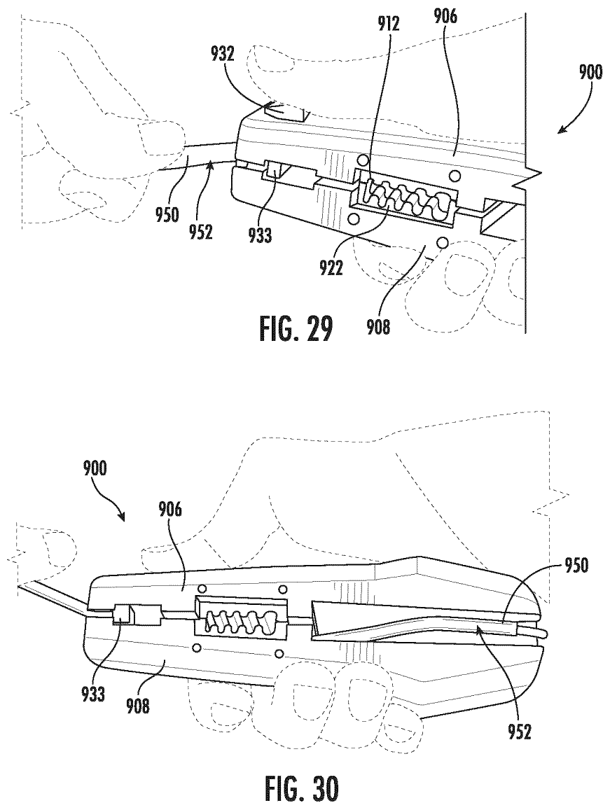

Referring to FIGS. 29-35, another method of using wire stripper 900 to cut, score, and strip cable 950 is shown. A user adjusts opening 930 to a desired size using slider 932. Then a user inserts cable 950 into wire stripper 900 at a desired strip length. Once positioned between first member 906 and second member 908, wire stripper 900 is moved to the closed position and a user squeezes first member 906 and second member 908 together to cut into cable jacket 952. After cable jacket 952 is cut, a user can pull cable 950 away from first end 902 while still holding wire stripper 900 in the closed position. This movement will pull cable jacket 952 from cable 950 and expose conductors 951. A user may then strip inner conductors 951 by positioning conductors between first U-shaped blades 912 and second U-shaped blades 922. When inner conductors 951 have been stripped, the user can create a J-hook and/or can terminate the exposed conductor wire by inserting the wire into a hole 934 and then bending the conductor 951 towards wire stripper 900.

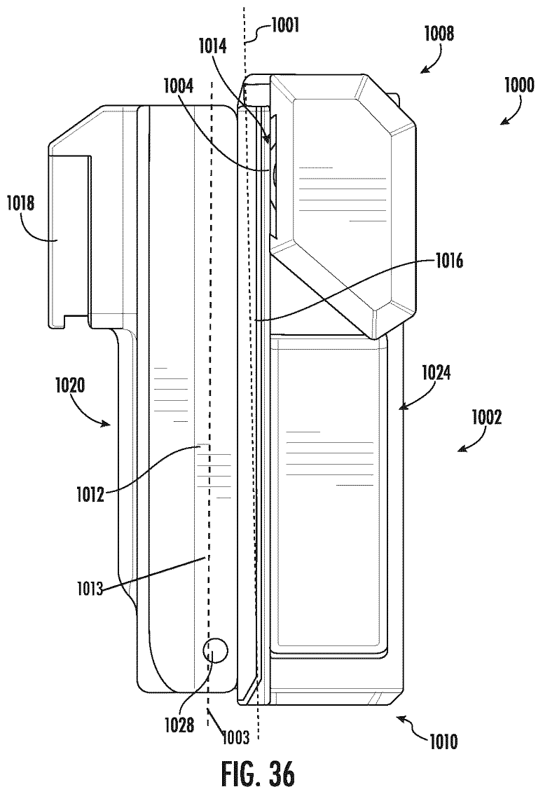

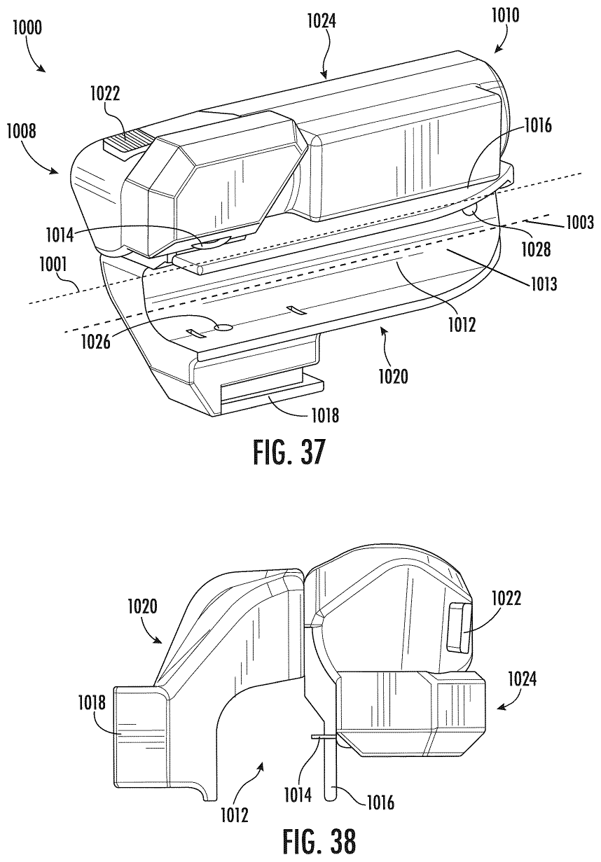

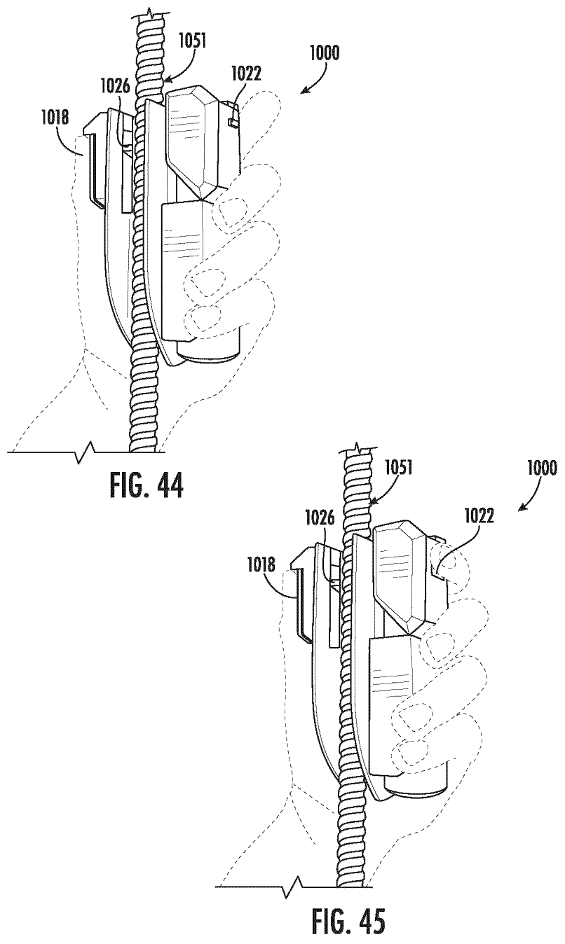

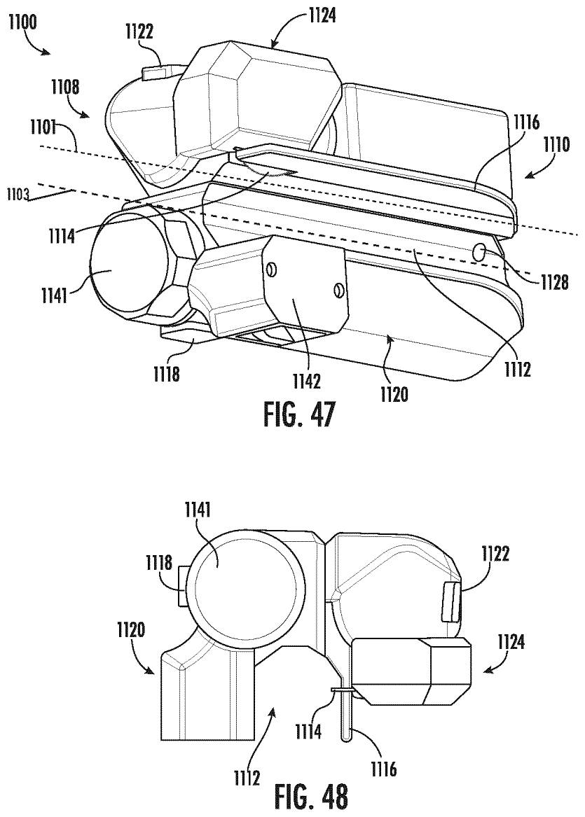

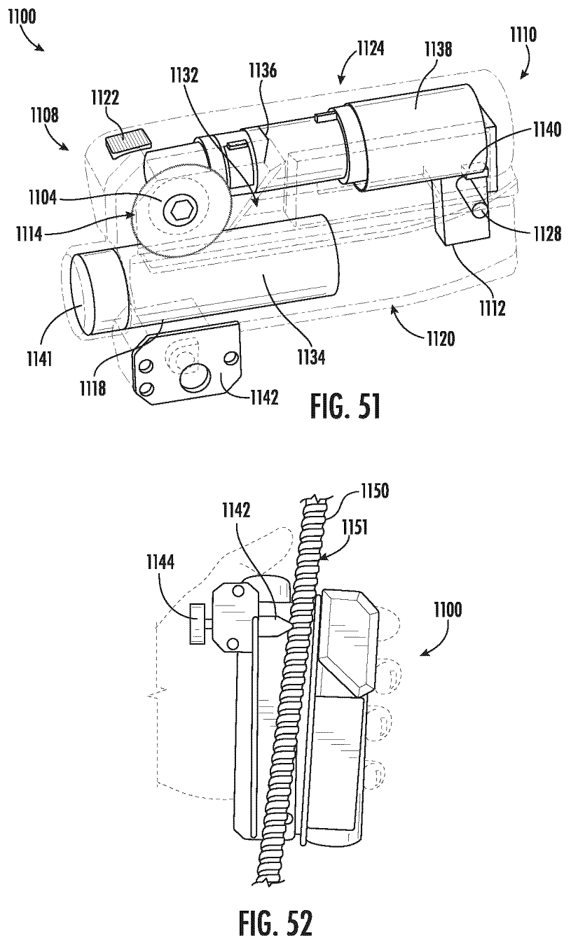

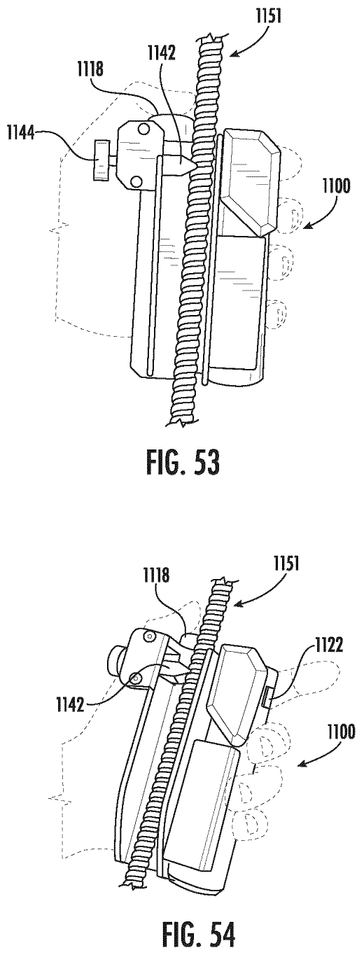

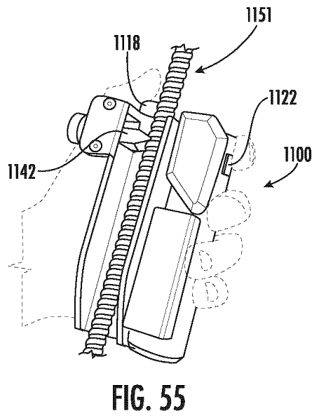

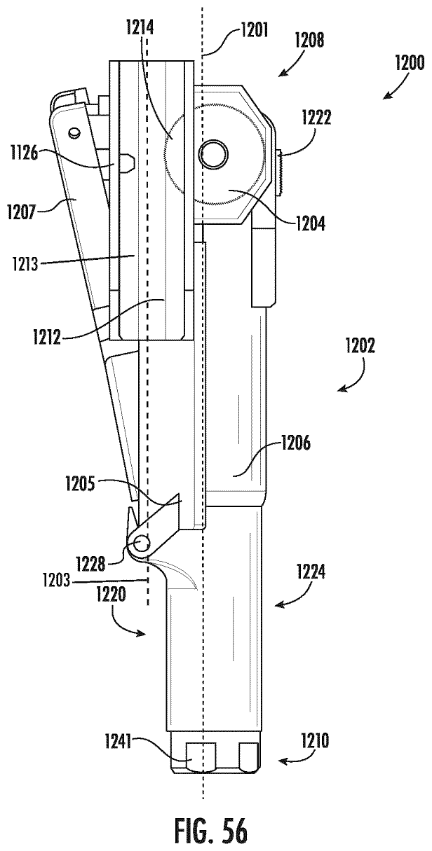

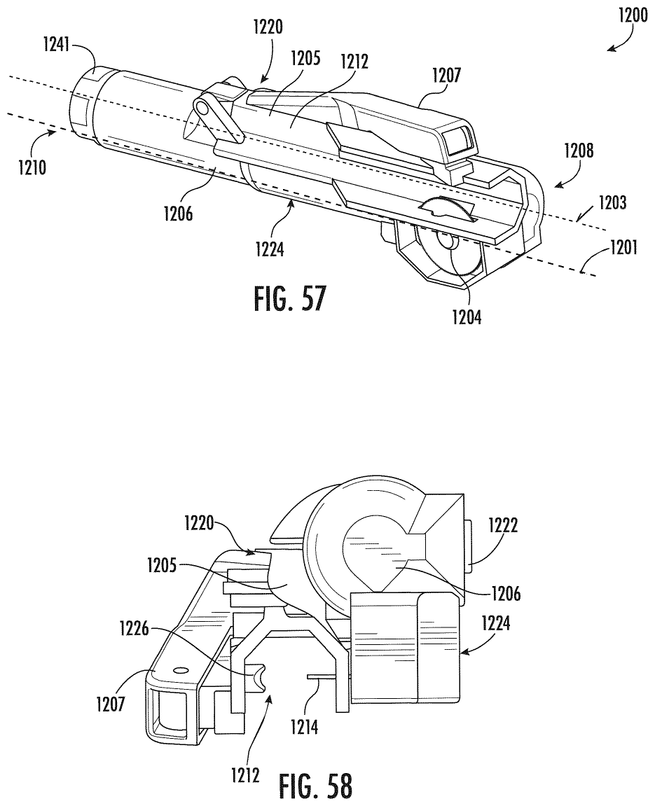

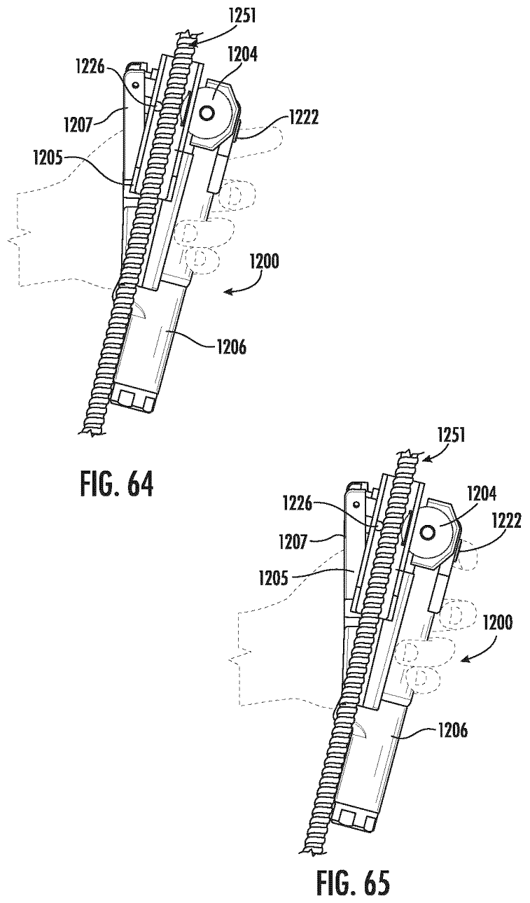

Referring generally to FIGS. 36-67, various embodiments of a motorized or electrically powered wire stripping tool are shown. These wire stripping tools are configured to receive, strip, and cut various sizes (e.g., 8-16 AWG, etc.) and types of metallic cables (e.g., metal-clad cables, armored cables, fire alarm control cables (FACC), armored fiber optic cables, etc.). The wire stripping tools include an electrically powered blade that rotates to strip and/or cut metallic cable jackets and may also cut through a coating layer around a metallic cable jacket. Applicant believes that by being electrically powered these wire stripping tools provide various benefits over hand-powered/mechanical wire strippers, which include a crank or lever that a user rotates to actuate the blade, such as being easier to use, due the blade being electrically (rather than manually) rotated and being easier to store due to the wire stripper being more compact.

Referring to FIGS. 36-45, a wire stripping tool, such as wire stripper 1000, is shown. Wire stripper 1000 includes a body 1002 and a blade 1004. Body 1002 includes a first end 1008 and a second end 1010 opposite first end 1008 along a first or longitudinal axis 1001. Body 1002 extends along longitudinal axis 1001 from first end 1008 to second end 1010. A channel 1012 is formed along body 1002 and is centered along a second or channel axis 1003. Channel 1012 is defined along body 1002 and extends from first end 1008 to second end 1010. Channel defines a recessed surface 1013 along body 1002 between a first side 1020 and a second side 1024 of body 1002. Recessed surface 1013 extends along body 1002 from first end 1008 to second end 1010.

Blade 1004 is rotatably coupled to body 1002. As shown, blade 1004 is a circular shape. Blade 1004 includes a cutting edge or outer edge 1014 configured to cut a workpiece. Blade 1004 is positioned along body 1002 adjacent to first end 1008. A portion of blade 1004 is located within channel 1012. Specifically, outer edge 1014 extends into channel 1012 and is configured to engage with a workpiece positioned within channel 1012. As shown, body 1002 includes a ridge 1016 that extends along body 1002 between first end 1008 and second end 1010. Ridge 1016 is located along channel 1012. Blade 1004 extends through ridge 1016 such that at least a portion of outer edge 1014 is located within channel 1012.

As shown, wire stripper 1000 further includes at least one actuator configured to rotate blade 1004. In particular, wire stripper 1000 includes two actuators, a first button 1018 located on first side 1020 of body 1002 and a second button 1022 located on second side 1024 of body 1002 opposite first side 1020. When a user presses first button 1018 and second button 1022, blade 1004 rotates and cuts a cable jacket of a workpiece positioned within channel 1012. As shown in FIG. 40, first button 1018 actuates a pin 1026. Pin 1026 is configured to engage a cable jacket positioned within channel 1012. When engaged with a cable jacket, pin 1026 may retain the cable jacket in channel 1012 when the cable jacket is stripped and/or cut. Pin 1026 may also push the cable jacket into engagement with blade 1004.

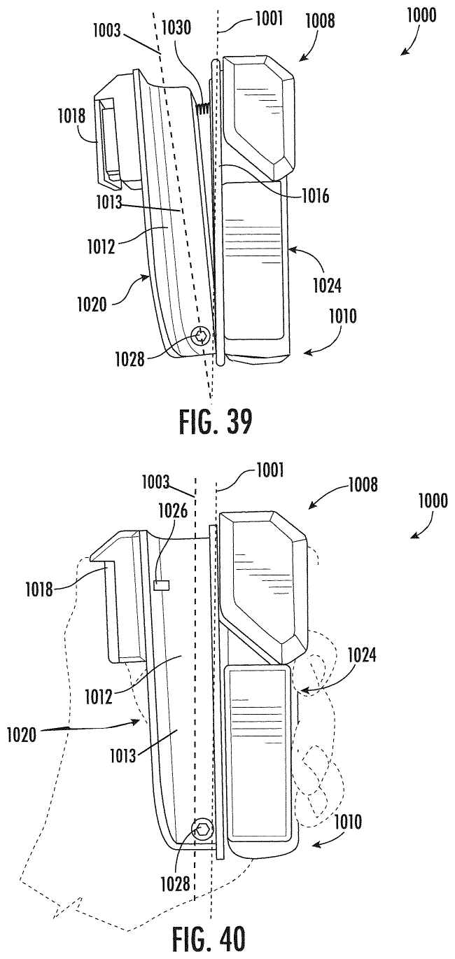

Wire stripper 1000, and more specifically body 1002, is configured to move between an opened position (as shown in FIG. 39) and a closed position (as shown in FIG. 40). As shown, when in the opened position, channel axis 1003 of channel 1012 intersects with longitudinal axis 1001 of body 1002, and, when in the closed position, channel axis 1003 is substantially parallel to longitudinal axis 1001.

Body 1002 includes a hinge 1028 and a biasing mechanism, shown as a spring 1030. Spring 1030 is configured to bias body 1002 towards the opened position. A user can move wire stripper 1000 from the opened position to the closed position by compressing body 1002 with a force greater than the biasing force of spring 1030. When in the opened position, channel 1012 has an increased width at first end 1008 of body 1002 than at second end 1010 of body 1002. That is, a first width of channel 1012 at first end 1008 of body 1002 is greater than a second width of channel 1012 at second end 1008 of body 1002. Applicant believes that by having an increased width of the channel 1012, a user can more easily insert a workpiece, such as a cable, into channel 1012. When in the closed position, the width of channel 1012 is substantially the same along the length of the channel 1012. That is, the first width and the second width are the same.

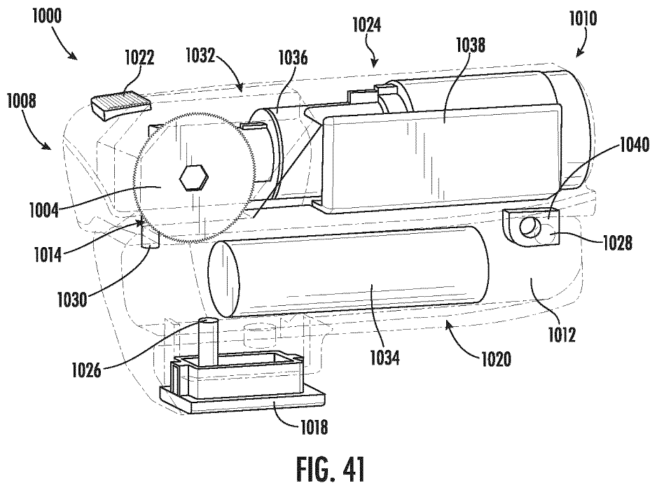

Referring to FIG. 41, body 1002 defines an internal cavity 1032 between first end 1008 and second end 1010. Internal cavity 1032 is configured to house a power source, such as a battery 1034, a gearbox 1036, a motor 1038, and a printed circuit board (PBC) 1040. Motor 1038 and gearbox 1036 are configured to rotate blade 1004 when motor 1038 receives power from battery 1034. As shown, battery 1034 is housed within internal cavity 1032 and is positioned along body 1002 behind channel 1012. In a specific embodiment, battery 1034 is a rechargeable battery. Battery 1034 is configured to provide power to motor 1038 when one or more actuators (e.g., first button 1018 and second button 1022) are engaged. When a user presses first button 1018 and second button 1022, power is provided from battery 1034 to motor 1038, and motor 1038 rotates blade 1004 to cut a cable jacket positioned within channel 1012.

Blade 1004 is configured to rotate when both first button 1018 and second button 1022 are pressed. Applicant believes that a two-button configuration may reduce unintentional actuation of wire stripper 1000 while the tool is in transit or is otherwise handled by a user. In particular, when first button 1018 is pressed, a switch is actuated to send a first electrical signal to PBC 1040, and when second button 1022, is pressed a second electrical signal is sent to PBC 1040. When PBC 1040 receives the first electrical signal and the second electrical signal at the same time, PBC 1040 directs power from battery 1034 to motor 1038. Motor 1038 rotates gears within gearbox 1036 and gearbox 1036 rotates blade 1004.

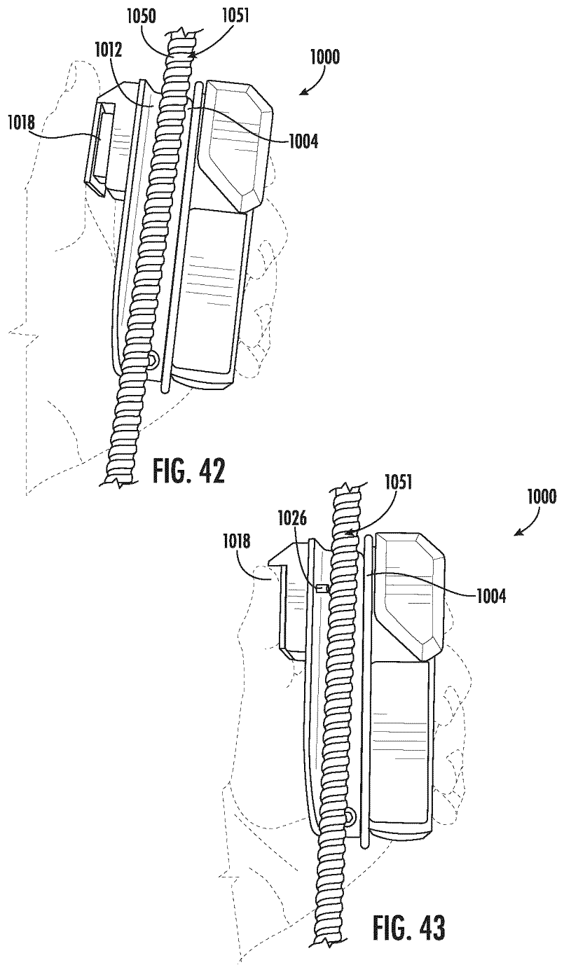

Referring to FIGS. 42-45, a method of using wire stripper 1000 to cut a workpiece, such as cable 1050, is shown. As shown, cable 1050 is a metallic cable, or a metal clad cable. Cable 1050 has a cable jacket 1051. First, while wire stripper 1000 is in the opened position, cable 1050 is inserted into channel 1012. Second, a user presses down on first button 1018 and moves pin 1026 into engagement with jacket 1051. When pressing first button 1018, the pressure applied to wire stripper 1000, moves wire stripper 1000 to the closed position and jacket 1051 is moved into engagement with blade 1004. When first button 1018 is pressed, first button 1018 actuates a switch. Third, a user presses second button 1022, which completes an electrical circuit when the switch is actuated and provides power to blade 1004. When first button 1018 and second button 1022 are pressed, blade 1004 rotates and cuts jacket 1051. If first button 1018 or second button 1022 are released, then blade 1004 will stop receiving power and will stop rotating. After cable jacket 1051 is cut, a user can remove cable 1050 from channel 1012. A user may then remove cable jacket 1051 by twisting jacket 1051 along the cut and pulling the cable jacket 1051 from cable 1050.

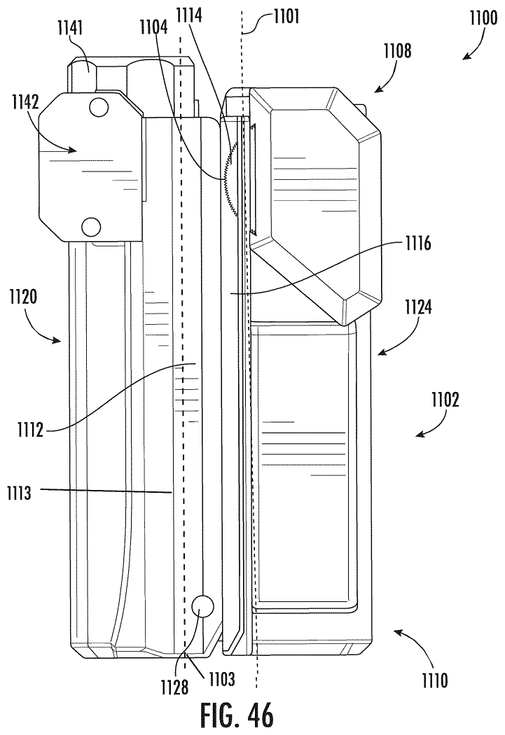

Referring to FIGS. 46-55, a wire stripping tool, such as wire stripper 1100, is shown. Wire stripper 1100 is substantially the same as wire stripper 1000, except for the differences discussed herein. Specifically, wire stripper 1100 includes an engagement prong or projection 1142 configured to move with respect to a channel 1112 such that projection 1142 can engage and disengage with a workpiece positioned within channel 1112.

As shown in FIGS. 46-51, wire stripper 1100 includes a body 1102 and a blade 1104. Body 1102 includes a first end 1108, a second end 1110 opposite first end 1108 along a longitudinal axis 1101, a first side 1120, and a second side 1124 opposite first side 1120. A channel 1112 is formed along body 1102 between first side 1120 and second side 1124. Channel 1112 is defined along body 1102 and extends from first end 1108 to second end 1110.

Blade 1104 includes a cutting edge or outer edge 1114 configured to cut a workpiece. Outer edge 1114 extends into channel 1112 and is configured to engage with a workpiece positioned within channel 1112. Outer edge 1114 extends through a ridge 1116 such that at least a portion of outer edge 1114 is located within channel 1112.

Body 1102 defines an internal cavity 1132 between first end 1108 and second end 1110. Internal cavity 1132 is configured to house a power source, such as a battery 1134, a gearbox 1136, a motor 1138, and a printed circuit board (PBC) 1140. Motor 1138 and gearbox 1136 are configured to rotate blade 1104 when motor 1138 receives power from battery 1134. Battery 1134 is configured to provide power to motor 1138 when one or more actuators or buttons are engaged. Body 1102 includes an end cap 1141 coupled to first end 1108. When end cap 1141 is removed or detached from body 1102, at least a portion of internal cavity 1132 can be accessed by a user. In particular, battery 1134 can be installed or replaced when user removes end cap 1141.

Body 1102 further includes at least one actuator configured to rotate blade 1104. As shown, body 1102 includes two actuators, a first button 1118 and a second button 1122. First button 1118 is located on first end 1108 of body 1102 near end cap 1141 and second button 1122 is located on second side 1124 of body 1102. Blade 1104 is configured to rotate when both first button 1118 and second button 1122 are pressed.

Wire stripper 1100 further includes projection 1142. Projection 1142 is configured to move with respect to channel 1112 such that projection 1142 engages and disengages with a workpiece, such as a cable, positioned within channel 1112 to retain the workpiece in channel 1112 when the workpiece is cut and/or stripped. Projection 1142 is coupled to first side 1120 of body 1102 and extends towards channel 1112. In particular, at least a position of projection 1142 is positioned within channel 1112. As shown, projection 1142 includes a biasing mechanism, such as a spring, and a handle, shown as a thumb screw 1144. The biasing mechanism and thumb screw 1144 are configured to move projection 1142 towards and away from channel 1112 to accommodate various sizes of cables. In particular, the biasing mechanism and thumb screw 1144 are configured to adjust the distance that projection 1142 extends into channel 1112. The biasing mechanism is configured to bias projection 1142 into engagement with a workpiece positioned within channel 1112, while thumb screw 1144 is configured to allow a user to move projection 1142 away from channel 1112 and out of engagement with a workpiece positioned within channel 1112.

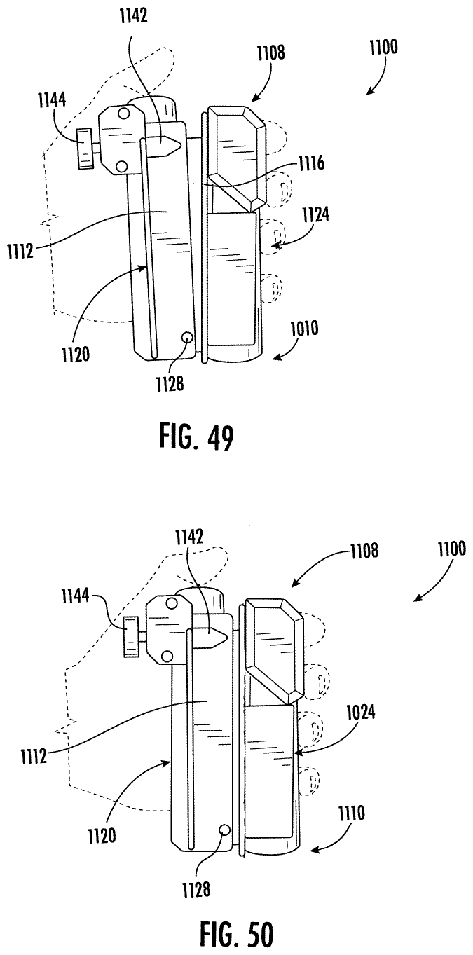

Wire stripper 1100 includes a hinge 1128 and a spring 1130, which allow wire stripper 1100 to move between an opened position (as shown in FIG. 49) and a closed position (as shown in FIG. 50). When in the opened position, channel 1112 has an increased width at first end 1108 of body 1102 than at second end 1110 of body 1102. When positioning a workpiece within channel 1112, a user may adjust the width of channel 1112 to accommodate different sizes and types of cables by moving wire stripper 1100 into the opened position and/or using thumb screw 1144 to retract projection 1142.

Referring to FIGS. 52-55, a method of using wire stripper 1100 to cut a workpiece, such as cable 1150 is shown. As shown, cable 1150 is a metallic cable, or a metal clad cable. Cable 1150 has a cable jacket 1151. First, while wire stripper 1100 is in the opened position, cable 1150 is inserted into channel 1112. When positioned in channel 1112, projection 1142 engages with cable jacket 1151 and pushes cable jacket 1151 into engagement with blade 1104. Second, the user moves wire stripper 1100 into the closed position by squeezing first side 1120 and second side 1124 of wire stripper 1100 together. Third, a user presses down on first button 1118. Fourth, a user presses second button 1122, which completes an electrical circuit and provides power to blade 1104. When first button 1118 and second button 1122 are pressed, blade 1104 rotates and cuts jacket 1151. After cable jacket 1151 is cut, a user can remove cable 1150 from channel 1112. A user may then remove cable jacket 1151 by twisting jacket 1151 along the cut and pulling the cable jacket 1151 from cable 1150.

Referring to FIGS. 56-65, a wire stripping tool, such as wire stripper 1200, is shown. Wire stripper 1200 is substantially the same as wire strippers 1000 and 1100, except for the differences discussed herein. Specifically, wire stripper 1200 includes a body 1202 with a first section 1205 and a second section 1206. When first section 1205 is moved towards second section 1206, a blade 1204 positioned on second section 1206 is moved into engagement with a channel 1212 defined along first section 1205 such that blade 1204 can cut and/or strip a workpiece positioned within channel 1212.

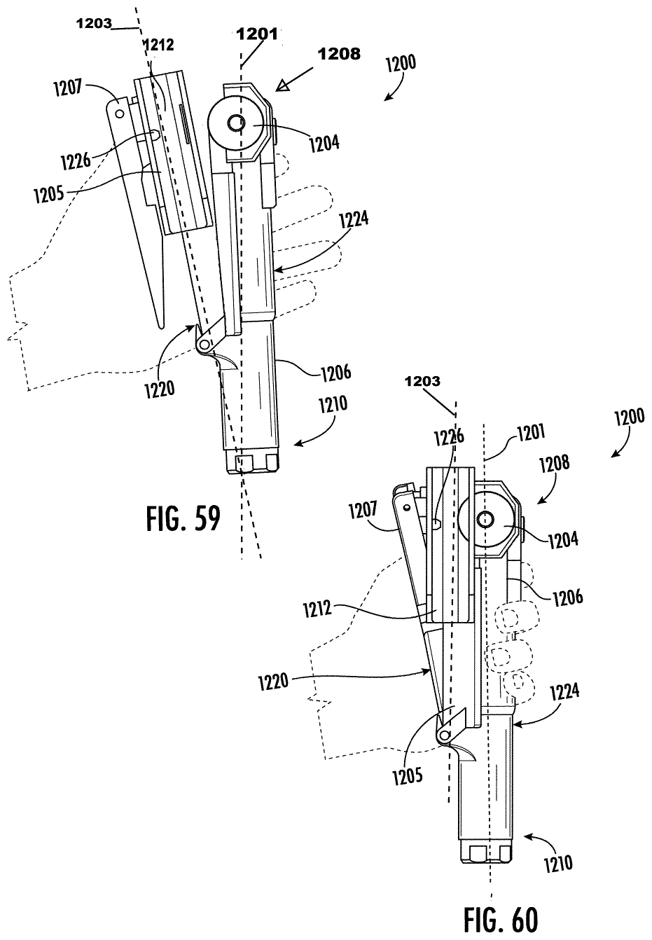

Referring to FIGS. 56-61, channel 1212 is defined along first section 1205 of body 1202 and extends along first section 1205 between first end 1208 and second end 1210. Channel 1212 is centered on a channel axis 1203 and defines a recessed surface 1213. Second section 1206 is centered on and extends along a longitudinal axis 1201. First section 1205 is configured to pivot with respect to second section 1206 of body 1202 between an opened position (as shown in FIG. 59) and a closed position (as shown in FIG. 60). As shown, when in the opened position, channel axis 1203 intersects longitudinal axis 1201, and when in the closed position, channel axis 1203 is parallel to longitudinal axis 1201.

A lever 1207 is coupled to a first side 1220 of body 1202 and configured to move body 1202 between the opened position and the closed position. Specifically, lever 1207 is pivotally coupled to first section 1205 of body 1202 and is configured to move between a first position and a second position with respect to body 1202, and more specifically first section 1205. Lever 1207 actuates a pin 1226. Pin 1226 is configured to engage a cable jacket positioned within channel 1212. When engaged with a cable jacket, pin 1226 may retain the cable jacket in channel 1212 when the cable jacket is stripped and/or cut. Pin 1226 may also push the cable jacket into engagement with blade 1204, when wire stripper 1200 is in the closed position.

When the lever 1207 is moved from the first position to the second position, lever 1207 is compressed and moves towards channel 1212. Lever 1207 moves first section 1205 of body 1202 towards second section 1206 of body 1202, and a first button or a switch is actuated by lever 1207. When the switch is actuated and a user presses a button 1222 positioned along second section 1206 of body 1202, then power is provided from a power source to rotate blade 1204 to strip and/or cut a cable jacket positioned within channel 1212.

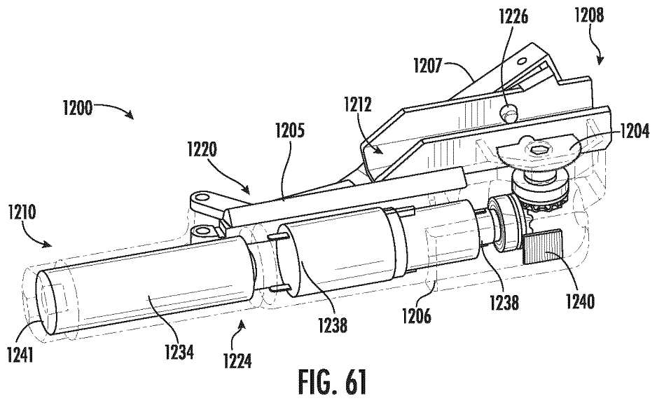

Referring to FIG. 61, body 1202 defines an internal cavity 1232 between first end 1208 and second end 1210. Specifically, internal cavity 1232 is defined within second section 1206 of body 1202. Internal cavity 1232 is configured to house a power source, such as a battery 1234, a gearbox 1236, a motor 1238, and a printed circuit board (PBC) 1240. Battery 1234 is configured to provide power to motor 1238 when lever 1207 and button 1222 are engaged. As shown, battery 1234, gearbox 1236, and motor 1238 are in an in-line configuration such that battery 1234, gearbox 1236, and motor 1238 are aligned in a direction along longitudinal axis 1201. In particular, motor 1238 is positioned between battery 1234 and gearbox 1236 in a direction along longitudinal axis 1201. Body 1202 further includes an end cap 1241 coupled to second end 1210 of second section 1206. When end cap 1241 is removed from body 1202, internal cavity 1232 can be accessed by a user. In particular, battery 1234 can be installed or replaced when user removes end cap 1241.

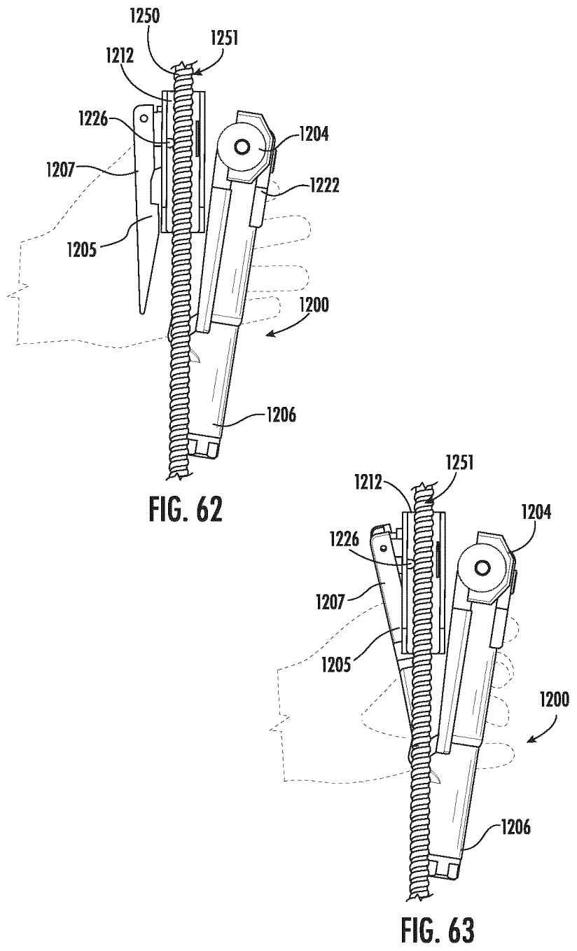

Referring to FIGS. 62-65, a method of using wire stripper 1200 to cut a workpiece, such as cable 1250 is shown. As shown, cable 1250 is a metallic cable, or a metal clad cable. Cable 1250 has a cable jacket 1251. First, while wire stripper 1200 is in the opened position, cable 1250 is inserted into channel 1212. Second, a user moves wire stripper 1200 into the closed position. In particular, a user squeezes or compresses lever 1207 towards channel 1212, which moves first section 1205 towards second section 1206. Once in the closed position, pin 1226 engages with cable jacket 1251 and cable jacket 1251 is moved into engagement with blade 1204. When in the closed position, first section 1205 actuates a switch. Third, a user presses button 1222, which completes an electrical circuit when the switch is actuated and provides power to blade 1204 to cut cable jacket 1251. If lever 1207 or button 1222 is released, then blade 1204 will stop receiving power and will stop rotating. After cable jacket 1251 is cut, a user can remove cable 1250 from channel 1212. A user may then remove cable jacket 1251 by twisting jacket 1251 along the cut and pulling the cable jacket 1251 from cable 1250.

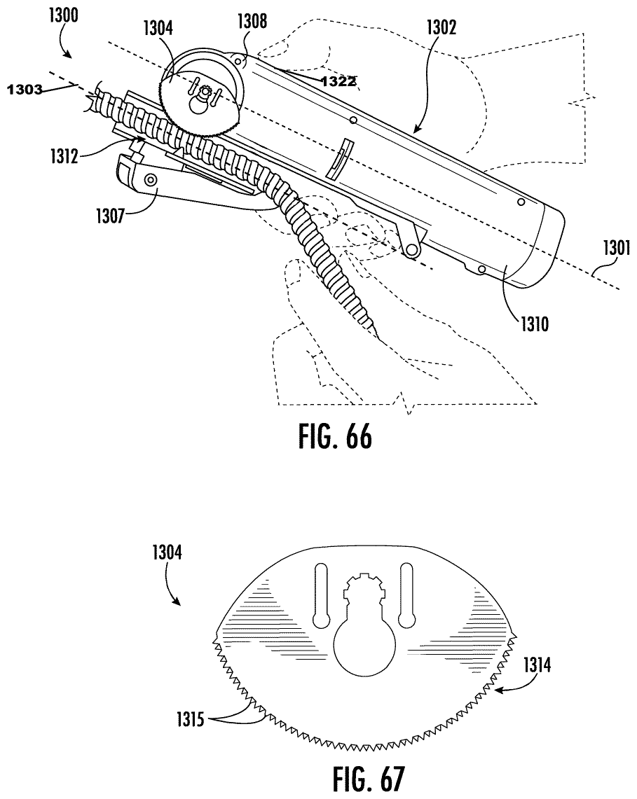

Referring to FIGS. 66-67, a wire stripping tool, such as wire stripper 1300, is shown. Wire stripper 1300 is substantially the same as wire strippers 800, 1000, 1100, and 1200, except for the differences discussed herein. Specifically, wire stripper 1300 includes a blade 1304 configured to saw, or oscillate, back and forth with respect to a channel 1312 to cut and/or strip a workpiece, such as a cable, positioned within channel 1312. Applicant believes that this blade structure provides benefits over other blades such as reducing the amount of power needed to cut a workpiece by reducing the overall movement of the blade, as well as reducing the risk of cutting inner conductor wires when cutting a cable jacket.

As shown, wire stripper 1300 includes a body 1302 and a lever 1307 is pivotally coupled to body 1302. Lever 1307 is configured to move between a first position and second position with respect to body 1302. Channel 1312 is defined along body 1302. When lever 1307 is moved from the first position to the second position, lever 1307 is compressed and moves towards channel 1312 and a workpiece, which as a cable jacket, positioned in channel 1312 is moved into engagement with blade 1304. Blade 1304 is configured to oscillate back and forth at a fixed point along channel 1312, rather than rotating in one direction. When power is provided to the motor, the motor moves blade 1304 resulting in blade 1304 swinging back and forth with respect to channel 1312 at a regular speed. As shown, blade 1304 includes cutting teeth 1315 formed along a portion of the outer edge 1314 of blade 1304. Cutting teeth 1315 are configured to engage with a cut and/or strip a workpiece. When in the closed position, cutting teeth 1315 are positioned within channel 1312. When in the closed position and a user presses button 1322, blade 1304 oscillates back and forth with respect to channel 1312 such that cutting teeth 1304 are configured to saw a workpiece positioned within channel 1312.

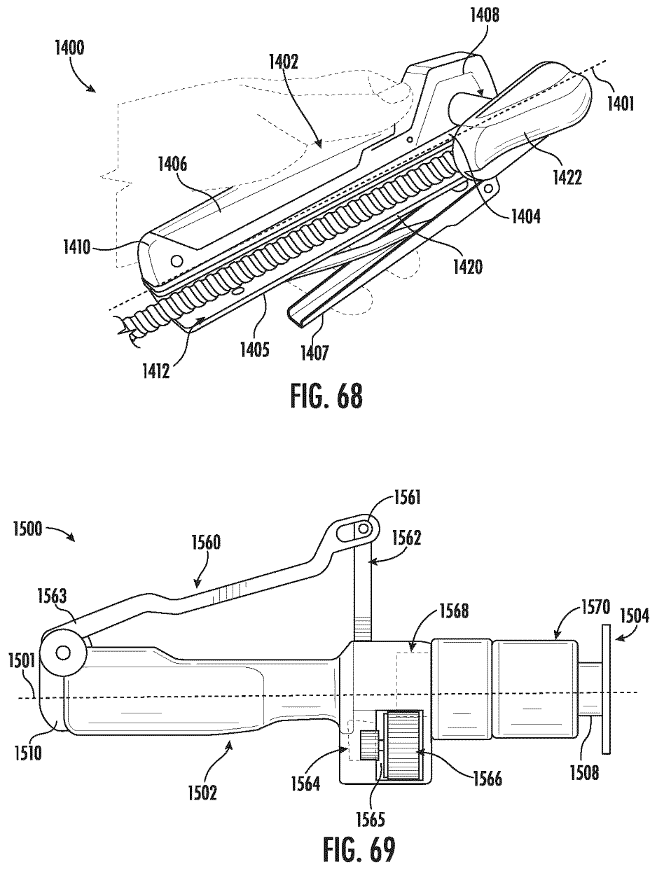

Referring generally to FIGS. 68-75, various embodiments of a wire stripping tool are shown. These wire stripping tools are configured to receive, strip, and cut various sizes (e.g., 8-16 AWG, etc.) and types of metallic cables (e.g., metal-clad cables, armored cables, fire alarm control cables (FACC), armored fiber optic cables, etc.). The wire stripping tools include a manually powered blade that a user can rotate to strip and/or cut metallic cable jackets and may also cut through a coating layer around a metallic cable jacket. The wire stripping tools include various structures for rotating the blade (e.g., a flywheel, ripcord, knob, etc.), which Applicant believes provides for various benefits over other hand-powered/mechanical wire stripping tools, which may include a crank or elongated lever that requires a wide crank radius when a user uses the crank to actuate the blade, such as reducing the size of the tool to allow the tool to be used in tighter spaces or stored more easily and making rotation of the blade more efficient.

Referring to FIG. 68, a wire stripping tool, such as wire stripper 1400, is shown. Wire stripper 1400 includes a body 1402 and a blade 1404. Body 1402 includes a first end 1408 and a second end 1410 opposite first end 1408 along a longitudinal axis 1401. A channel 1412 is formed along body 1402. Body 1402 includes with a first section 1405 and a second section 1406. Channel 1412 is defined along first section 1405 of body 1402 and extends from first end 1408 to second end 1410. When first section 1405 is moved towards second section 1406, blade 1404, which is positioned on second section 1406, is moved into engagement with channel 1412 defined along first section 1405 such that blade 1404 can cut and/or strip a workpiece positioned within channel 1412.

A lever 1407 is coupled to a first side 1420 of body 1402. Specifically, lever 1407 is pivotally coupled to first section 1405 of body 1402 and is configured to move between a first position and a second position with respect to body 1402, and more specifically first section 1405. When the lever 1407 is moved from the first position to the second position, lever 1407 is compressed and moves towards channel 1412. Lever 1407 moves first section 1405 of body 1402 towards second section 1406 of body 1402, such that at least a portion of blade 1404 is located within channel 1412 to engage with a workpiece (e.g., a cable jacket).

Blade 1404 is rotatably coupled to body 1402 and includes a cutting edge or outer edge configured to cut a workpiece. Blade 1404 is positioned along body 1402 adjacent to first end 1408. A handle or knob 1422 is coupled to blade 1404 and configured to rotate blade 1404 with respect to body 1402. When a user rotates knob 1422, blade 1404 rotates. As shown, to cut a workpiece positioned within channel 1412, a user compresses lever 1407 to move blade 1404 into engagement with the workpiece and then rotates knob 1422 to strip and/or cut the workpiece.

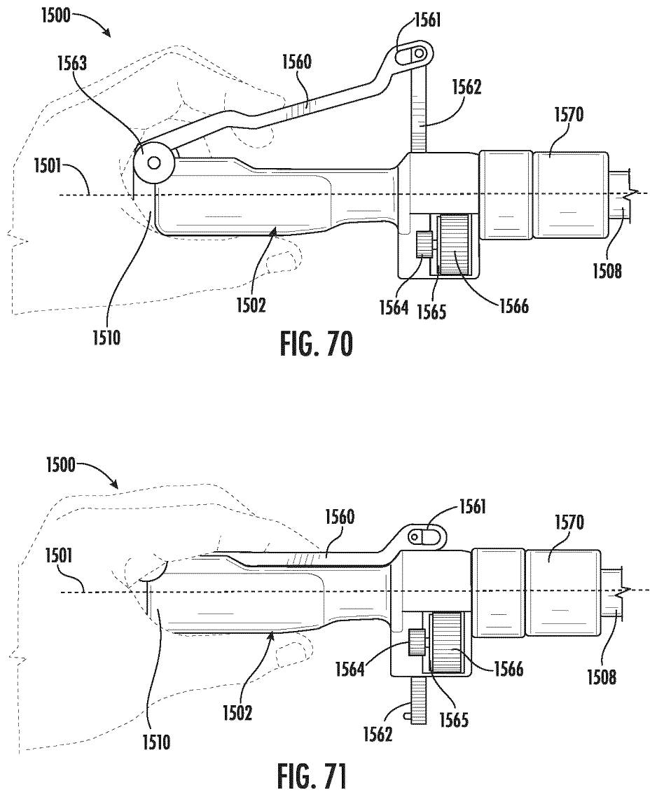

Referring to FIGS. 69-71, a wire stripping tool, such as wire stripper 1500, is shown. Wire stripper 1500 includes a body 1502 and a blade 1504 rotatably coupled to body 1502. Body 1502 includes a first end 1508 and a second end 1510 opposite first end 1508 along a longitudinal axis 1501. A handle 1560 is coupled to body 1502. Handle 1560 includes a first end 1561 and a second end 1563 opposite first end 1561. As shown, second end 1563 of handle 1560 is pivotally coupled to second end 1510 of body 1502. Handle 1560 is configured to move between a first position (as shown in FIG. 70) and a second position (as shown in FIG. 71) with respect to body 1502. In a certain embodiment, handle 1560 includes a biasing mechanism, such as a spring, that biases handle 1560 towards the first position.

Blade 1504 is coupled to first end 1508 of body 1502. When handle 1560 is moved from the first position to the second position, blade 1504 is configured to rotate in a first circumferential direction around longitudinal axis 1501.

Wire stripper 1500 further includes a gear rack 1562 coupled to handle 1560. Gear rack 1562 extends from first end 1561 of handle 1560 towards body 1502. In particular, an end of gear rack 1562 is located within body 1502. Gear rack 1562 engages with a first gear, shown as input pinion gear 1564, and is configured rotate input pinion gear 1564. Input pinion gear 1564 is coupled to a second gear, shown as input shaft gear 1566, and is configured to rotate input shaft gear 1566. Input shaft gear is coupled to a third gear, shown as output gear 1568, and is configured to rotate output gear 1568. Output gear 1568 is coupled to blade 1504 and is configured to rotate blade 1504. When handle 1560 is moved from the first position to the second position, or in a first direction towards body 1502, gear rack 1562 rotates input pinion gear 1564. Input pinion gear 1564 rotates input shaft gear 1566, which rotates output gear 1568. Output gear 1568 then rotates blade 1504. In this way, gear rack 1562 drives rotation of blade 1504 in the first circumferential direction when handle 1560 is moved from the first position to the second position.

As shown, wire stripper 1500 includes a bearing, shown as one-way bearing 1565, positioned between input pinion gear 1564 and input shaft gear 1566. Bearing 1565 only transmits rotation of input pinion gear 1564 to input shaft gear 1566 when handle 1560 is moved in the first direction from the first position to the second position. Thus, when handle 1560 moves in a second direction opposite the first direction from the second position to the first position, rotation of input pinion gear 1564 is not transferred to input shaft gear 1566 such that blade 1504 is not rotated when handle 1560 moves in the second direction.

Wire stripper 1500 also includes an output mass 1570. Output mass 1570 is configured to gain momentum when output gear 1568 rotates in order to maintain rotation of blade 1504 when handle 1560 is not moved from the first position to the second position. As shown, output mass 1570 is positioned between output gear 1568 and blade 1504. In other certain embodiments, blade 1504 may be positioned between output gear 1568 and output mass 1570.

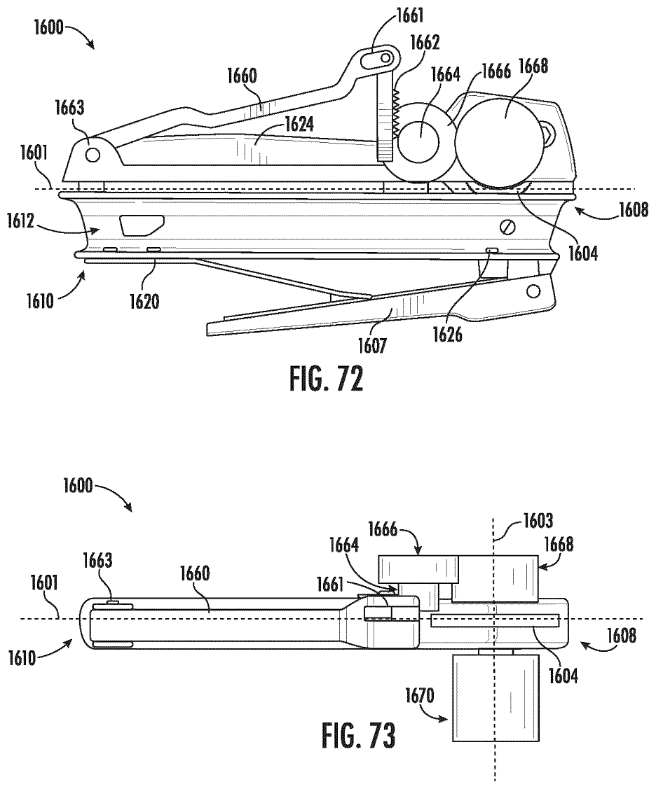

Referring to FIGS. 72-73, a wire stripping tool, such as wire stripper 1600, is shown. Wire stripper 1600 is substantially the same as wire stripper 1500, except for the differences discussed herein. In particular, a body 1602 of wire stripper 1600 includes a channel 1612 configured to receive a workpiece, such as a cable.

Wire stripper 1600 includes a blade 1604 rotatably coupled to a first end 1608 of body 1602. Blade 1604 is configured to rotate with respect to body 1602 and more specifically around a blade axis 1603. Blade axis 1603 is perpendicular to longitudinal axis 1601. Channel 1612 is formed along body 1602 and extends from first end 1608 of body to a second end 1610 of body 1602. A portion of blade 1604 is positioned within channel 1612. In particular, a portion of outer edge of blade 1604 is positioned within channel 1612.

A lever 1607 is coupled to a first side 1620 of body 1602. Lever 1607 actuates a pin 1626. Pin 1626 is configured to engage a cable jacket positioned within channel 1612. When engaged with a cable jacket, pin 1626 may retain the cable jacket in channel 1612 when the cable jacket is stripped and/or cut. Pin 1626 may also push the cable jacket into engagement with blade 1604, when lever 1607 is moved towards body 1602, in order to cut and/or strip the cable jacket.

Wire stripper 1600 further includes a handle 1660 coupled to a second side 1624 of body 1602. When handle 1660 is configured to move between a first position and a second position with respect to body 1602. When handle 1660 is moved from the first position to the second position, a gear rack 1662 rotates an input pinion gear 1664. Input pinion gear 1664 rotates an input shaft gear 1666, which rotates an output gear 1668. Output gear 1668 then rotates blade 1604. In this way, gear rack 1662 drives rotation of blade 1604 in the first circumferential direction when handle 1660 is moved from the first position to the second position. As shown, blade 1604 is positioned between output gear 1668 and an output mass 1670. Output mass 1670 is configured to maintain rotation of blade 1604 when handle 1660 is stationary with respect to body 1602 and/or moved from the second position to the first position with respect to body 1602.

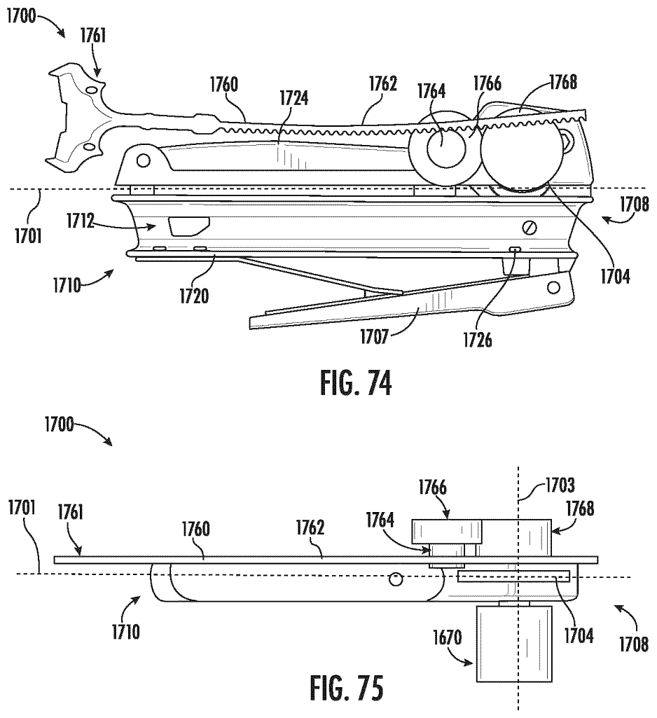

Referring to FIGS. 74-75, a wire stripping tool, such as wire stripper 1700, is shown. Wire stripper 1700 is substantially the same as wire strippers 1500 and 1600, except for the differences discussed herein. In particular, wire stripper 1700 includes a cord, shown as ripcord 1760, that engages with an input pinion gear 1764 to rotate a blade 1704.

Ripcord 1760 includes a handle or grip 1761 and a ratchet 1762 coupled to grip 1761. To rotate blade 1704, a user moves ripcord 1760 in a first direction away from first end 1708 of body 1702 and away from second end 1710 of body 1702. When moved in the first direction, ratchet 1762 of ripcord 1760 rotates input pinion gear 1764. Input pinion gear 1764 rotates an input shaft gear 1766, which rotates an output gear 1768. Output gear 1768 then rotates blade 1704. In this way, ripcord 1760 drives rotation of blade 1704 in the first circumferential direction. As shown, blade 1704 is positioned between output gear 1768 and an output mass 1770. In a specific embodiment, wire stripper 1700 includes a bearing positioned between input pinion gear 1764 and input shaft gear 1766. The bearing allows rotation of input pinion gear 1764 to not be transferred to input shaft gear 1766 when ripcord 1760 is moved in a second direction opposite the first direction such that blade 1704 is not rotated when ripcord 1760 moves in the second direction.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A powered wire stripping tool, comprising:
a body centered on and extending along a longitudinal axis, the body comprising:
a first end;
a second end opposite the first end along the longitudinal axis;
a first side extending between the first end and the second end;
a second side opposite the first side, the second side extending between the first end and the second end;
an internal cavity defined within the body and enclosed between the first side, the second side, the first end, and the second end; and
a channel formed along the body, the channel defining a recessed surface along the body between the first side and the second side, the recessed surface extending along the body from the first end to the second end;
a blade rotatably coupled to the body, the blade having an outer edge that extends into the channel;
a motor positioned within the internal cavity and configured to rotate the blade;
a power source positioned within the internal cavity and configured to provide power to the motor;
a first button coupled to the first side of the body; and
a second button coupled to the second side of the body; and
wherein, when a user presses the first button and the second button, the power source provides power to the motor and the motor rotates the blade such that a workpiece positioned within the channel can be cut by the blade.

2. The powered wire stripping tool of claim 1, wherein the body is configured to move between an opened position and a closed position, wherein, the channel extends along a channel axis, and wherein, when in the opened position, the channel axis of the channel intersects with the longitudinal axis of the body.

3. The powered wire stripping tool of claim 2, wherein when in the closed position, the channel axis is parallel to the longitudinal axis.

4. The powered wire stripping tool of claim 2, wherein the body further comprises a spring configured to bias the body towards the opened position.

5. The powered wire stripping tool of claim 2, wherein, when in the opened position, the channel has a first width at the first end of the body that is greater than a second width at the second end of the body.

6. The powered wire stripping tool of claim 5, wherein, when in the closed position, the first width and the second width are the same.

7. The powered wire stripping tool of claim 1, further comprising a pin, wherein the pin is configured to move with respect to the channel when a user presses the first button such that the pin can engage a workpiece positioned within the channel.

8. The powered wire stripping tool of claim 1, wherein the power source is positioned within the internal cavity behind the channel.

9. The powered wire stripping tool of claim 1, wherein the power source is a battery, wherein the body further comprises an end cap removably coupled to the first end of the body, wherein, when the end cap is removed, at least a portion of the internal cavity can be accessed by a user such that the user may install or replace the battery.

10. A wire stripper, comprising:
a body, comprising:
a first end;
a second end opposite the first end;
a first section comprising a channel, the channel defining a recessed surface along the body between the first end to the second end;
a second section extending along a longitudinal axis and defining an internal cavity, wherein the first section is pivotally coupled to the second section;
a blade coupled to the second section of the body, the blade configured to move with respect to the channel;
a motor positioned within the internal cavity and configured to move the blade;
a power source positioned within the internal cavity and configured to provide power to the motor;
a lever pivotally coupled to a first side of the body along the first section of the body, the lever configured to move the body between an opened position and a closed position; and
a button coupled to the second section of the body;
wherein, when the body is in the closed position at least a portion of the blade is positioned within the channel; and
wherein, when the body is in the closed position and a user presses the button, the power source provides power to the motor and the motor moves the blade such that a workpiece positioned within the channel can be cut by the blade.

11. The wire stripper of claim 10, wherein when the lever is moved towards the channel, the lever moves the first section towards the second section, and the body is moved into the closed position.

12. The wire stripper of claim 11, wherein the channel is centered on and extends along a channel axis, wherein when in the opened position, the channel axis intersects with the longitudinal axis of the body, and wherein when in the closed position, the channel axis is parallel to the longitudinal axis of the body.

13. The wire stripper of claim 10, wherein the power source is a battery, wherein the body further comprises an end cap removably coupled to the second end of the body along the second section, wherein, when the end cap is removed, at least a portion of the internal cavity can be accessed by a user such that the user may install or replace the battery.

14. The wire stripper of claim 10, wherein the blade comprises an outer edge, wherein a portion of the outer edge defines cutting teeth, wherein when in the closed position the cutting teeth are positioned within the channel, and wherein, when the body is in the closed position and a user presses the button, the blade oscillates back and forth with respect to a fixed position along channel such that the cutting teeth are configured to saw a workpiece positioned within the channel.

15. The wire stripper of claim 10, wherein the motor and the power source are in an in-line configuration within the internal cavity such that the motor and power source are aligned in a direction along the longitudinal axis.

16. A wire stripping tool, comprising:
a body configured to move between an opened position and a closed position, the body comprising:
a first end;
a second end opposite the first end along a longitudinal axis;
an internal cavity defined within the body between the first end and the second end; and
a channel formed along the body and extends along a channel axis, the channel defining a recessed surface along the body, the recessed surface extending along the body from the first end to the second end;
a blade rotatably coupled to the body, the blade having an outer edge that extends into the channel when the body is in the closed position;
a motor positioned within the internal cavity and configured to rotate the blade;
a power source positioned within the internal cavity and configured to provide power to the motor; and
a button coupled to the body and configured to selectively provide power from the power source to the motor, wherein, when a user presses the button, the power source provides power to the motor and the motor rotates the blade; and
wherein, when in the opened position, the channel axis of the channel intersects with the longitudinal axis of the body.

17. The wire stripping tool of claim 16, wherein, when in the closed position, the channel axis of the channel is parallel to the longitudinal axis of the body.

18. The wire stripping tool of claim 17, wherein the channel is centered on the channel axis.

19. The wire stripping tool of claim 16, further comprising a biasing mechanism coupled to the body and a projection coupled to the biasing mechanism, the projection configured to move with respect to the channel, wherein the biasing mechanism is configured to bias the projection into engagement with a workpiece positioned within the channel.

20. The wire stripping tool of claim 19, wherein a thumb screw is coupled to the projection, wherein the thumb screw is configured to allow a user to selectively move the projection within respect to the channel.
